(19) United States
(12) Patent Application Publication
(10) Pub. No.: US 2024/0275601 A1
(43) Pub. Date: Aug. 15, 2024

(54) Systems And Methods For State Minimization And Unlinkable Transactions

(71) Applicant: Zorp Corp, Tyler, TX (US)

(72) Inventors: Logan Allen, Cedar Park, TX (US); Brian Klatt, Woodbury Heights, NJ (US)

(21) Appl. No.: 18/441,759

(22) Filed: Feb. 14, 2024

Related U.S. Application Data
(60) Provisional application No. 63/484,866, filed on Feb. 14, 2023.

(51) Int. Cl. H04L 9/32; G06Q 20/36

(52) U.S. Cl. CPC H04L 9/3221; G06Q 20/36

(57) ABSTRACT

A computer-based system, computer-implemented method, and computer program product for state minimization and unlinkable transactions leverage a zero-knowledge (ZK) verifier system implemented on blockchain network(s). The ZK system is configured to, via a ZK virtual machine, verify a block of block(s) of a state-minimized decentralized ledger and recursively verify a corresponding zero-knowledge proof (ZKP) of a predecessor block of the block. The block is associated with an electronic transaction. The ZK system is further configured to generate an unlinkable transaction by obfuscating a correlation between a source node and a destination node of node(s) of the network(s). The source and destination nodes are associated with the transaction. The ZK system is further configured to validate the transaction by verifying a ZKP corresponding to the unlinkable transaction.

### RELATED APPLICATION

This application claims the benefit of U.S. Provisional Application No. 63/484,866, filed on Feb. 14, 2023. The entire teachings of the above application are incorporated herein by reference.

### BACKGROUND

A blockchain may be implemented as a peer-to-peer (P2P), electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

Blockchain may be used for implementation of “smart contracts” that can be associated with digital asset. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets.

An area of blockchain-related interest is the use of “tokens” to represent and transfer assets via the blockchain. A token serves as an identifier that allows an asset to be referenced from the blockchain. Fungible tokens are uniform. In other words, fungible tokens of the same type are identical in specification, and each fungible token is identical to another fungible token of the same type. Fungible tokens may be divisible into smaller amounts. Similar to currency, where bills can be divided into coins of an equivalent value, fungible tokens may be divisible. Non-fungible tokens (NFTs), however, cannot be replaced with other tokens of the same type. NFTs represent non-fungible assets. Non-fungible assets have unique information or attributes. Each NFT is unique and differs from other tokens of the same class, and, unlike a fungible token, NFTs typically cannot be divided. Blockchain gaming systems may use tokens or NFTs to create different parts of the game, such as rules, characters, weapons, and skins.

Cryptocurrency wallets may be implemented to securely store and manage blockchain assets, tokens, NFTs, and cryptocurrencies. These wallets may allow users to spend, receive, and trade digital assets.

### SUMMARY

An ordered tree is a useful data structure with many applications. Some representations of incomplete ordered trees may have slow performance for operations such as subtree retrieval and modification, such as where the tree is incomplete. Certain embodiments may configure ordered trees in a manner that is more amenable to speedups and optimizations in various domains, including tree-based memory representation (which can potentially be utilized by ordered tree-centric virtual machines (VMs)), and zero-knowledge proof (ZKP) systems, e.g., ZKP systems based on polynomials defined over finite fields. Some embodiments may divide an ordered tree into two items, a structure-encoding codeword and a leaf vector. The codeword may be defined as a Dyck word that traces out a depth-first traversal of the tree, and the leaf vector may be a vector or contiguous array of all values found at the tree's leaf nodes. Certain embodiments may perform operations of subtree retrieval and/or modification more efficiently across numerous domains.

In a computer system that uses, e.g., potentially incomplete ordered trees and implements them via linked memory pointers, a time complexity of O(log(n)) pointer dereferences for each memory retrieval or modification can become a performance bottleneck, as accessing a series of non-contiguous values in a computer's RAM (random-access memory) may cause cache thrashing. Cache thrashing is a problem that may occur in modem CPUs (central processing units) when memory is accessed in a pattern that results in excessive processor cache misses. Performing many pointer dereferences can make a system inefficient and thus unable to meet certain performance criteria, preventing it from becoming a viable system. In a computer system that makes use of potentially incomplete ordered trees using standard array implementations, there may be space complexity issues if the trees in question largely skew to one side, as known array-based ordered tree implementations may use the same amount of memory as if the tree were complete, leading to large amounts of wasted memory space. Similarly, array-based implementations of ordered trees may be inefficient when subtrees are appended or removed, or when they otherwise have their shape modified substantially. Such inefficiencies regarding modification of shape may lead to a system being infeasible to use in practice due to performance concerns.

On the cryptographic side, existing proof systems that represent valid computation using finite fields and polynomial constraints may make emulating CPU architecture an arduous process. Either toy models of computation—which may not be realistic—may be chosen to serve as proofs of concept but may not be productionizable, or staggering efficiency costs may be incurred in practical models unless complex conceptual constructions are employed. This circumstance is not surprising: computers are marvelous feats of practical engineering, but the low-level details of how memory is handled within these machines may not be a Platonically beautiful mathematical construction. However, cryptographic constructions may be much closer to the elegant, crystalline, and logical necessity of the mathematical realm. Such impedance mismatches may be sources of friction and inefficiency when trying to express logical invariants of a computational model in terms of stepwise mathematical constraints. To place a square peg in a round hole, you must first learn to whittle—it may be better to start with round pegs. Thus, having a system of memory management enveloped in a data structure with strong mathematical content may hold potential for great gains in efficiency for these cryptographic proof systems.

There is a fork in the history of computation, an alternative to Turing's machine and its direct descendant in the von Neumann architecture: combinatory logic and the lambda calculus, and their descendants in the functional programming paradigm. These more mathematical views of computation, rooted in mathematical logic (and later, category theory) may abstract away details of implementation, and as models of computation may therefore be much closer to a round peg for the round hole of cryptographic proof systems. With its S-expressions, the functional programming language LISP may show the expressive power of representing data and programs in terms of a single data structure.

Example embodiments disclosed herein provide computational systems, e.g., an encoding or arithmetization computational system, that can reduce friction of building VMs, such as VMs that use ordered trees for non-limiting example, and address performance issues noted above and improve efficiency. In an example embodiment, an improved cryptographic proof system may be provided that is configured to structure data that allows for representing potentially incomplete ordered trees in a manner that has superior asymptotics: linear space complexity to a size of a tree, O(1) pointer dereferences involved in traversal and retrieval, O(1) pointer dereferences involved in subtree editing when a subtree to be modified has the same number of elements as a previous one, and amortized O(1) subtree editing when a number of elements in an old subtree varies from that of a new subtree, for non-limiting examples. An example representation according to principles of the present disclosure may include two components: a tree structure-encoding codeword and a contiguous array, e.g., vector, of leaves, e.g., fixed-size leaves. The structure-encoding codeword may be a Dyck word that captures a shape of data inside an ordered tree. The set of possible Dyck words may have a bijection to a set of shapes of ordered binary trees. Specifically, a Dyck word may encode a shape of a binary ordered tree as a series of bits representing opening and closing symbols in an order that they would be accessed in an exemplary depth-first search (DFS) or traversal of the tree. The leaf vector may be a contiguous array, e.g., list, of data held at leaf nodes of the ordered tree, in the order that they are accessed in the exemplary DFS.

In an example embodiment, a computational system (e.g., an encoding computational system) may be provided that is configured to generate ZKPs, e.g., succinct ZKPs, of binary ordered tree traversal and/or subtree retrieval. The system may be configured with a tree traversal and subtree retrieval system that particularly improves performance and is optimized for dealing with incomplete trees. An example benefit of this ZKP generation is that there may be Turing complete, combinator-like (i.e., functional) machine specifications based on (typically, incomplete) binary tree traversal and subtree access, and which treat memory and/or programs homoiconically; that is, both may be represented uniformly within a binary tree data structure. This may offer a superior path to zero-knowledge proving—especially within current systems, which may use finite fields and/or polynomial constraints—that may avoid pitfalls associated with proving general computations by attempting to emulate a von Neumann CPU architecture.

In an example embodiment, a computational system, e.g., an encoding computational system, may be configured to record a DFS through a tree to find a desired subtree by traversing bits of a Dyck word up to a beginning of the targeted subtree, while recording a local count that keeps track of shapes of subtrees occurring prior to and/or along a path leading to the desired subtree. A traversal may be performed, e.g., simultaneously, of a bitwise representation of a target location of the subtree, iterating 1 (one) bit forward when, e.g., the local count is equal to 0 (zero). Once the bitwise representation of the target location of the subtree has been iterated through, a start index of the target subtree location may be discovered. After the location of the start of the target subtree has been discovered, a first time that the local count reaches a value of −1 (negative one) may signify an index of an end of a Dyck word of the target subtree. At this point, both the start and end indices of the target subtree may have been retrieved from the original tree in question and the subtree may have been retrieved. The generation of this encoding of a DFS may be performed with a time complexity that scales, e.g., linearly, with a size of a binary tree being traversed. It may be further optimized to achieve a time complexity that scales, e.g., logarithmically, with the size of the binary tree by avoiding traversal of subtrees that are not along a direct path to a target subtree by identifying them through a use of lookup tables that record a shape and size of subtrees.

In an example embodiment, data-structural advantages and optimization may be provided. In an existing implementation of a binary ordered tree via use of memory pointers, for example, a subtree retrieval may typically require dereferencing an average of log(n) pointers where n is defined as a number of elements in the tree. With novel data encoding techniques disclosed herein, a subtree may be retrieved by first using a codeword, which may represent a tree shape as a Dyck word, to calculate pointer offsets of start and end indices of the subtree in question, and then performing a singular pointer dereference using a pointer offset and a pointer to a start of a leaf vector or array, e.g., a contiguous vector or array. Calculating the location of a subtree path using a codeword, e.g., a Dyck word, may improve performance because it may employ bit operations, which may be highly efficient on all (or nearly all) modem processors. As such, techniques according to principles of the present disclosure may provide a practical means of accelerating retrieval of subtrees. Moreover, certain embodiments may be used to modify leaf values of a tree in place with the same performance characteristics. If it is desired to replace a subtree with a subtree of a different shape, some embodiments may recompute a new Dyck word and replace a shape codeword. Then, if a size of the new subtree is the same as the old subtree, certain embodiments may replace memory locations in place. Otherwise, some embodiments may set a pointer to a new contiguous array that contains leaves of the new subtree. Together with including a bit flag inside each leaf in the array that signifies whether the value is a memory pointer to the data in question or a data literal, this may allow some embodiments to provide amortized O(1) modifications to the shape of the tree. A “compaction” operation may be used in certain embodiments to replace pointers to subtrees with a subtree expressed as a literal, hence use of the term “amortized.”

The technique of storing a pair of (i) a codeword (e.g., Dyck word) and (ii) an array of leaves described hereinabove may also be amenable to efficient encoding. Certain zero-knowledge proving schemes, such as STARKs (Scalable Transparent Arguments of Knowledge) and SNARKs (Succinct Non-Interactive Arguments of Knowledge), may use encoding. One of the criteria of proof systems such as STARKs and SNARKs may be succinctness, which is an idea that a verifier system should be able to establish validity of a computational integrity statement with significantly less computational time or power compared to that of the original computation performed by a prover system. As part of a verification process, a verifier may evaluate certain polynomial constraints to see if they are valid. If a computational integrity statement is not conducive to efficient encoding or is otherwise expensive to verify, a verifier may in practice have to do a lot of computational work, degrading the system's ability to meet a succinctness criterion. Thus, efficient encoding may translate to less computational overhead and thus a proof system with improved performance, lowering a minimum computational resource requirement and thus allowing more participants to become verifiers. Similarly, if a computational integrity statement is not conducive to encoding or otherwise expensive to prove, a prover component of a system may have to do more computational work than is practical, resulting in drastically reduced performance and fewer potential use cases for such a system.

One or more factors may give rise to efficient encoding (and thus lower prover and verifier compute burden), which can include, for non-limiting examples:
a) low number of total constraints for a given proof system;
b) low degree of constraint polynomials; and/or
c) low numbers of columns and/or rows required in tables that a prover may use to construct polynomials given to a verifier.

When a process and its invariants can easily be encoded with a low number of polynomial operations, the process may be more likely to have the properties of efficiency described hereinabove.

Example embodiments can provide more efficient encoding and can allow for efficient validation and demonstration that some arbitrary data indeed represents a Dyck word. This validation may include one or more of the following exemplary criteria:
a) the data is a valid bitstring (contain only 1s (ones) and 0s (zeroes));
b) the data has an equal amount of 1s (ones) and 0s (zeroes); and/or
c) the number of 1s (ones) is less than or equal to the number of 0s (zeroes) for all subsequences or substrings of the Dyck word that begin at a first character.

Some or all of the above exemplary criteria may be efficiently representable as polynomial constraints, because they may not require more than encoding operations offered by polynomials. Once a segment of data in a proof system has been shown to be a valid Dyck word, the rest of a proof could use that fact to further verify that data in various parts of a given ordered tree were accessed consistently and correctly (i.e., in depth-first order), paving the way for the system to generate proofs of retrieval and even modification operations on ordered trees if desired. Such proofs' performance may benefit from the efficiency of the method described.

Embodiments thus include a computer-based system for state minimization and unlinkable transactions. In an example embodiment, the system includes a zero-knowledge VM (ZKVM). The system may further include a state-minimized decentralized ledger having multiple blocks. The state-minimized decentralized ledger may be configured as a dynamic cryptographic accumulator implementing a decentralized ledger protocol. The system may further include a blockchain computer network having multiple nodes. A node of the multiple nodes of the blockchain computer network may be configured to execute a zero-knowledge verifier system. The zero-knowledge verifier system may be configured to, via the ZKVM, verify a block of the multiple blocks based on a block header of the block and at least one ZKP of the multiple blocks. The block may be associated with an electronic transaction. The zero-knowledge verifier system may be further configured to, via the ZKVM, recursively verify a corresponding ZKP of at least one predecessor block of the block. The zero-knowledge verifier system may be further configured to generate an unlinkable transaction by obfuscating a correlation between a source node of the multiple nodes and a destination node of the multiple nodes. The source node and the destination node may be associated with the electronic transaction. The zero-knowledge verifier system may be further configured to validate the electronic transaction by verifying a ZKP corresponding to the generated unlinkable transaction. The ZKP may be configured to attest to correctness of the generated unlinkable transaction and satisfaction of smart contract logic associated with a digital wallet.

According to an example embodiment, the dynamic cryptographic accumulator may include a sparse Merkle tree. In another example embodiment, the state-minimized decentralized ledger may be configured to computationally index at least one leaf of the sparse Merkle tree based on at least one content predicate.

In an example embodiment, the dynamic cryptographic accumulator may be configured to perform a non-inclusion proof.

According to an example embodiment, the digital wallet may be a first digital wallet. The zero-knowledge verifier system may be further configured to implement a binding between a second digital wallet and a smart contract. The smart contract may include at least one covenant module configured to apply a conditional constraint to at least one future transaction associated with the second digital wallet.

In an example embodiment, the digital wallet may be a first digital wallet. The zero-knowledge verifier system may be further configured to determine a state penalty value for a second digital wallet corresponding to the destination node. The state penalty value may be associated with a state entry for the second digital wallet in the state-minimized decentralized ledger. The zero-knowledge verifier system may be further configured to, responsive to receiving a state trim request from the destination node, computationally purge the state entry in the state-minimized decentralized ledger.

According to an example embodiment, the node of the multiple nodes of the blockchain computer network may include a secure cryptoprocessor implemented as a dedicated microprocessor configured to execute the zero-knowledge verifier system. The zero-knowledge verifier system may be embedded on the secure cryptoprocessor.

Embodiments further include a computer-based system for tree encoding and decoding. In an example embodiment, the system includes at least one processor and a memory with computer code instructions stored thereon. The at least one processor and the memory, with the computer code instructions, may be configured to cause the system to execute an encoder. The encoder may be configured to transform a first incomplete binary ordered tree data structure into a first tree encoding based on an encoding scheme. The first tree encoding may include a first Dyck word and a first leaf vector. The encoding scheme may be capable of representing an arbitrary potentially incomplete binary ordered tree data structure in terms of a Dyck word and a leaf vector. The at least one processor and the memory, with the computer code instructions, may be further configured to cause the system to execute a decoder. The decoder may be configured to transform a second tree encoding into a second incomplete binary ordered tree data structure, where the second tree encoding includes a second Dyck word and a second leaf vector, by traversing the second tree encoding and incrementally parsing the second leaf vector.

In an example embodiment, the decoder may be further configured to generate a subtree data structure based on a subtree index variable.

According to an example embodiment, the system may further include a VM configured with a potentially incomplete ordered tree based memory model. The VM may be further configured with the encoding scheme. The VM may be further configured with at least one of the encoder and the decoder.

In an example embodiment, the system may further include a cryptographic proof system configured to, based on the encoding scheme, represent a first statement of computational integrity in terms of polynomials defined over finite fields. The first statement of computational integrity may relate to at least one of traversal and modification of at least one potentially incomplete binary ordered tree data structure. According to another example embodiment, the cryptographic proof system may be further configured to, based on the encoding scheme, verify a second statement of computational integrity. The second statement of computational integrity may be in terms of polynomials defined over finite fields and relate to at least one of traversal and modification of at least one potentially incomplete binary ordered tree data structure.

In an example embodiment, the encoder is further configured to process a polynomial-based representation of a computational integrity statement. The polynomial-based representation may be associated with a ZKP system. According to another example embodiment, the ZKP system may be at least one of a STARK based system and a SNARK based system.

Alternative computer-implemented method and computer program product embodiments parallel those described above in connection with the example computer-based system embodiments.

It should be understood that example embodiments disclosed herein can be implemented in the form of a computer-implemented method, apparatus, computer-based system, or computer program product.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram of an exemplary depth-first search (DFS) on a tree according to an example embodiment.

FIG. 2 illustrates an exemplary conversion from a tree to a Dyck word according to an example embodiment.

FIG. 3 illustrates exemplary trees and their corresponding Dyck words according to an example embodiment.

FIG. 4 illustrates an exemplary recursive form of a Dyck word of a generalized tree, according to an example embodiment.

FIG. 5 illustrates an exemplary transformation or conversion from a tree to a Dyck word and leaf vector encoding, according to an example embodiment.

FIG. 6 illustrates an exemplary encoding process according to an example embodiment.

FIG. 7 illustrates an exemplary decoding process according to an example embodiment.

FIG. 8A illustrates an exemplary tree according to an example embodiment.

FIG. 8B illustrates the exemplary tree of FIG. 8A, including subtrees, according to an example embodiment.

FIG. 9 illustrates an exemplary tree according to another example embodiment.

FIG. 10A is a generalized diagram of an exemplary tree having subtrees, according to an example embodiment.

FIG. 10B illustrates the exemplary tree of FIG. 10A annotated with a path word sequence according to an example embodiment.

FIG. 10C illustrates the exemplary tree of FIG. 10A where each subtree is annotated with its respective axis identifier, according to an example embodiment.

FIG. 10D illustrates the exemplary tree of FIG. 10A where each subtree is labeled, according to an example embodiment.

FIG. 11 illustrates an exemplary conflict node according to an example embodiment.

FIG. 12 illustrates an exemplary method for accessing a subtree according to an example embodiment.

FIG. 13 illustrates an exemplary table of a Dyck encoding according to an example embodiment.

FIG. 14 illustrates an exemplary table of a Dyck encoding according to another example embodiment.

FIG. 15 illustrates an exemplary table of a Dyck encoding with column descriptions according to an example embodiment.

FIG. 16 is a flow diagram of an exemplary computer-based system/method for state minimization and unlinkable transactions according to an embodiment.

FIG. 17 is a block diagram of an example embodiment of a distributed blockchain ledger computer-implemented system.

FIG. 18 is a block diagram of an example implementation of a network in communication with an embodiment.

FIG. 19 is a block diagram of any internal structure of a computer/computing node in a processing environment of an example embodiment.

FIG. 20 is a block diagram showing exemplary blockchain layers according to an embodiment.

FIG. 21 is a block diagram of an example user identification system according to an embodiment.

FIG. 22 is a block diagram of an example embodiment of a system for state minimization and unlinkable transactions.

FIG. 23 is a block diagram of an example embodiment of a system for tree encoding and decoding.

### DETAILED DESCRIPTION

A description of example embodiments follows.

### INTRODUCTION

In general, blockchain is a write-once, append-many type electronic ledger. Blockchain is an architecture that allows disparate users to make transactions and creates an unchangeable record of those transactions. To move anything of value over any kind of blockchain, a network of nodes must first agree that a corresponding transaction is valid. As a peer-to-peer (P2P) network, combined with a distributed time-stamping server, blockchain ledgers can be managed autonomously to exchange information between disparate parties; there is no need for an administrator. In effect, the blockchain users are the administrator.

Blockchain's rapid development has given rise to many different kinds of chains, leading to cross-chain technology. Cross-chain, as its name suggests, allows the transmission of value and information between different blockchains. According to an example embodiment, a digital asset may be exchanged, cross-chain, securely, and despite differences between constraints or rules of operation that may be established for the different blockchains. Such a digital asset may be in the form of a token, which may be fungible, or may be a non-fungible token (NFT). Such constraints or rules may be in the form of smart contracts, or other forms. Differences between such constraints or rules may include disparate levels of rigor or leniency of such constraints or rules between or among different blockchain networks.

In some embodiments, blockchain may be a P2P, electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

For a transaction to be written to the blockchain, it must be “validated.” Network nodes (miners) may perform work to ensure that each transaction is valid, with invalid transactions being rejected from the network. Software clients installed on the nodes may perform this validation work on an unspent transaction (UTXO) by executing its locking and unlocking scripts. If execution of the locking and unlocking scripts evaluates to TRUE, the transaction is valid and is written to the blockchain. Thus, for a transaction to be written to the blockchain, it should be: (i) validated by a first node that receives the transaction—e.g., if the transaction is validated, the node relays it to other nodes in the network; (ii) added to a new block built by a miner; and (iii) mined, e.g., added to the public ledger of past transactions.

Blockchain may be used for implementation of “smart contracts” that can be associated with digital assets. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets. Such assets may include real property, personal property (including both tangible and intangible property), digital assets such as software, or any other type of asset. In the digital economy, there is often an expectation that exchanges and transfers will be performed in a timely manner and across vast distances. This expectation, along with practical, technical limitations, means that traditional forms of asset transfer, such as physical delivery of hardcopy of documents representing a contract, negotiable instrument, etc., or a tangible asset itself, are not desirable. Thus, smart contracts can provide enhanced control, efficiency, and speed of transfer.

An area of blockchain-related interest is a use of “tokens” to represent and transfer assets via the blockchain. A token thus serves as an identifier that allows a real-world item to be referenced from the blockchain. Through an initial coin offering (ICO) model, startups may raise capital by issuing tokens on a blockchain, such as Ethereum, and distributing them to token buyers in exchange for making a financial contribution to a project. These tokens, which may be transferred across a network and traded on cryptocurrency exchanges, may serve a multitude of different functions, from granting holders access to a service to entitling them to company dividends. Depending on their function, tokens may be classified as security tokens or utility tokens.

Tokens may be used, for instance, in an initial public offering (IPO) to issue, e.g., company shares, dividends, and/or voting rights over blockchain networks. The tokens may include, e.g., security tokens and/or utility tokens. The security tokens may be associated with a value that is derived from a tradable asset and, thus, may be deemed a security token that may be subject to federal laws regulating traditional securities. In contrast, the utility tokens may represent future access to a company's product(s) and/or service(s). A defining characteristic of the utility token is that it is not designed as an investment. Because a utility token is not issued in the form of an investment asset, it may be exempt from having to comply with federal legislation regulating securities.

Further, similar to physical assets, the tokens that represent them may have many properties, one of which is fungibility or non-fungibility. In economics, fungibility refers to equivalence or interchangeability of each unit of a commodity with other units of the same commodity. Fungible tokens (FTs) are tokens that can be exchanged for any other token with the same value.

Fungible tokens are uniform, that is, FTs of the same type are identical in specification. In other words, each FT is identical to another FT of the same type, and FTs are divisible into smaller amounts. Similar to currency, where bills can be divided into coins of an equivalent value, FTs are divisible. As such, a fraction of an FT can be transferred between users. NFTs, however, cannot be replaced with other tokens of the same type. NFTs represent nonfungible assets, e.g., assets that have unique information or attributes. Each NFT is unique and differs from other tokens of the same class. For example, while plane tickets from and to a same destination may look the same, each one has a different passenger name, seat number, etc., and, therefore, is unique. In contrast to FTs, NFTs cannot be divided, an elementary unit of the NFT is the token itself.

Due to an immutable nature of transaction histories supported by blockchain networks, it is possible to extend the aforementioned validation steps of such transactions so that the transactions become subject to certain rules that reference prior transactions, or even aspects of an initial creation of a subject digital asset, e.g., a NFT. An example of such rules is an arrangement wherein royalties are paid to a creator of a digital asset each time the digital asset is sold to a subsequent owner. Such royalty payment arrangements may be implemented as a function with which the blockchain network is programmed, or using a reference table loaded into a computer memory element of the blockchain network, as a smart contract as described hereinabove, or by other means.

An ordered tree may be a type of binary tree that has a unique ordering for all vertices of the tree. In other words, there may be a well-defined sequential numbering assigned to each vertex of the tree. An ordered tree can contain values at its leaves and ordered trees at non-leaf vertices. Any vertex that is a non-leaf node may also be referred to as a subtree of a root tree. An ordered tree may be described as complete if every layer of the tree is filled with nodes, and incomplete otherwise. Systems that use ordered trees may traverse such a tree as part of performing operations such as retrieving or modifying arbitrary subtrees, among other examples. A representation of an ordered tree inside a computer program may be based on memory pointers, where each inner vertex of the ordered tree may contain two pointers, for instance, one to the vertex's left subtree and one to the vertex's right subtree. In such a scheme, the computational time complexity of running retrieval and modification operations may scale logarithmically with regard to input size. In practical terms, this means that to retrieve or modify a particular subtree in a given tree, it may be necessary to dereference O(log(n)) memory pointers, where n may be a variable defined as a number of leaves in the tree. Other representations of ordered trees may use arrays instead of pointer links between nodes; array-based implementations may deal only with complete trees, or may otherwise deal with incomplete trees by allocating enough memory to include a complete tree and placing null elements in place of missing elements.

A modern CPU (central processing unit) architecture in a von Neumann model may be designed with a goal of practical, Turing-complete computation. In the context of modern cryptography, there may be argument-of-knowledge systems of general Turing-complete calculation where, additionally, trust may not be assumed between a party interested in an outcome of a computation and a party who has resources to perform the computation. These two parties may agree on a model of computation and a cryptographic system that mathematically forces trust.

Certain proof systems may use tables, where a table may be a recorded trace of a state of a program at each individual step. A prover may engage within an agreed upon protocol to convince a verifier that the prover's program trace table obeys certain agreed upon state evolution invariants that, if met, the verifier can trust that the whole program was run correctly. These invariants about the program's evolution may be represented as polynomials defined over finite fields that operate on a row-by-row basis of tables used in a proof. In general, encoding may be a process of converting a set of rules, assertions, and/or computational invariants into one or more constraint polynomials that are produced using a combination of finite field polynomial encoding operations (i.e., addition, subtraction, multiplication, and division).

If a general computation models itself after a CPU architecture—which may involve access to traditional unstructured random-access memory (RAM)—it may be necessary to prove not only correct execution of the computation, but also soundness of interactions with memory. For example, if modeling a common read-write model of RAM, then a value read from a particular memory location may match a last value written to that location. Taking another example where arithmetic may be done on numbers that are stored in boxes (analogous to memory locations), if another party is not constrained from changing the numbers in the boxes in the middle of the calculation, there may be no reason to trust a final result, even if the right sequence of operations was correctly performed.

In such a case, technical obstacles may arise as part of ensuring consistency of reads and writes, which can be nonlocal and nonperiodic. This may be a very unnatural scenario for the strictures of current proof systems compatible with the general computation model, which may use a fixed set of polynomial constraints on data from a finite field and only validate correct execution of consecutive steps within a computation. This may necessitate committing to two different views of the computation with different constraints: one ordered by sequential steps of the computation, and another primarily ordered by memory address and then sub-ordered by sequential step. However, a problem may arise that two tables may separately satisfy these two different kinds of constraints, but be completely unrelated. Therefore, it may be necessary to make an additional argument that rows of the two tables are related by a permutation.

Alternatively, a different RAM memory model may be used, for example, by using a form of read-only memory (ROM). With further simplifying assumptions (e.g., “nondeterministic,” “continuous” read-only memory), such a model can become amenable to state evolution governed by polynomial constraints over a finite field.

In an example embodiment, a zero-knowledge verifier system according to principles of the present disclosure may be accomplished by use of, e.g., a zero-knowledge proof (ZKP). A zero-knowledge proof implementation in the zero-knowledge verifier system may ensure enforcement of encoded rules configured in digital assets (e.g., NFTs (non-fungible tokens)) utilizing a technique whereby a first entity (or “prover”), such as first transacting entity, a first wallet etc., may cryptographically prove to a second transacting entity (or “verifier”) that the first entity possesses knowledge regarding certain information regarding encoded rule(s) configured in a digital asset, without also disclosing the actual contents of the information.

ZKPs may be interactive or non-interactive. An interactive ZKP requires interaction between a prover entity and a verifier entity involved in a digital asset encoded rule enforcement transaction processed by the multinetwork digital asset control system. A non-interactive ZKP may be constructed from any interactive scheme by relying on, e.g., a Fiat-Shamir heuristic, or any other suitable technique known to those of skill in the art.

According to an example embodiment, a protocol implementing ZKPs may be presented as a transcript where a prover (first entity) responds to interactive inputs from a verifier (second entity). In another example embodiment, the interactive input may be in the form of one or more challenges such that responses from the prover will convince the verifier if and only if a statement is true, e.g., if the prover does possess certain asserted knowledge.

In the context of blockchain networks, according to some embodiments, by employing a ZKP, the only information divulged on-chain is that some piece of undisclosed information is (i) valid and (ii) known by the prover with a high degree of certainty. As such, in an example embodiment, ZKPs may be used by various blockchains to furnish privacy-maintaining digital asset transactions, whereby, for example, a transaction's amount, sender electronic wallet identifier, and receiver electronic wallet identifier are kept secret. Furthermore, some embodiments relate to oracle networks that provide smart contracts with access to off-chain data and/or computing infrastructure. Such oracle networks may also employ ZKPs to prove a certain fact about off-chain data, without divulging the data itself on-chain. A method used for performing non-interactive ZKPs may be as described in D. Unruh, “Non-Interactive Zero Knowledge Proofs in the Random Oracle Model,” in EUROCRYPT 2015, 2015, pp. 755-84, which is herein incorporated by reference in its entirety.

Further, a method for creating and executing ZKP applications in embedded systems may be as described in Salleras, et al., “ZPiE: Zero-Knowledge Proofs in Embedded Systems,” Mathematics, vol. 9, no. 20, p. 2569, 2021, which is herein incorporated by reference in its entirety.

A zero-knowledge proof may be used for verifiable computation, such as in distributed systems, for non-limiting example. Using a ZKP may be more efficient and/or less costly than proving or even running a computation itself. Further, in a blockchain context, for non-limiting example, leveraging ZKPs may allow for proving a computation a single time and verifying the computation multiple times.

Subsequent to the filing of U.S. Provisional Application No. 63/484,866, aspects of the invention have been published in Allen et al., “EDEN—a practical, SNARK-friendly combinator VM and ISA,” Cryptology ePrintArchive, 2023, pp. 1-34 and Allen et al., “Airwalk: Accessible Decentralized Ledgers with State-Minimization and Unlinkable Smart Transactions,” pp. 1-41, both of which are herein incorporated by reference in their entirety and further attached hereto as Appendices A and B, respectively.

### Dyck Words

According to an example embodiment, Dyck words describe a depth-first search (DFS) into a binary tree, i.e., a tree data structure in which each node has at most two children, referred to as a left child and a right child.

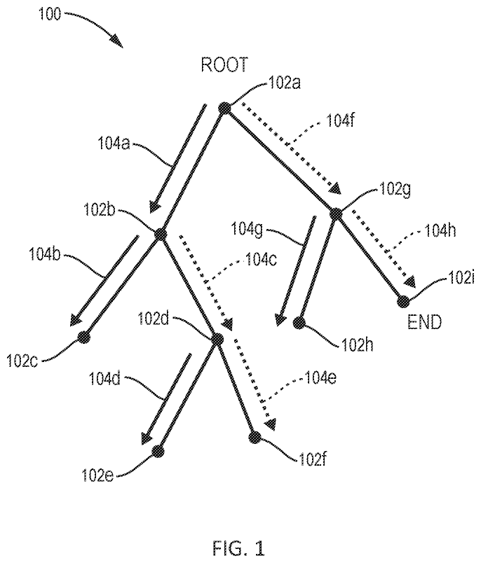

FIG. 1 is a diagram of an exemplary DFS on a tree 100, e.g., a binary tree, according to an example embodiment. An exemplary process for DFS is as follows:
a) Start at a root node of a tree.
b) Given a current node, if a left child has not yet been explored, continue searching from the left child. If any left child has been explored already, continue searching from a right child. Otherwise, if any right child has also been explored, then return to a parent node, if any.
c) Continue searching until all nodes in the tree have been visited or traversed.

In an example embodiment, as shown in FIG. 1, an exemplary DFS of the tree 100 may start at root node 102a, search left to visit child node 102b, and then search left again to arrive at node 102c. Next, the DFS may return to node 102b and search right to visit child node 102d, followed by searching left to arrive at node 102e. The DFS may then return to node 102d and search right to visit child node 102f. After visiting node 102f, because no unvisited nodes may remain on the left branch of root node 102a, the DFS may then return to root node 102a and search right to arrive at child node 102g. Once at node 102g, the DFS may search left and then right to visit nodes 102h and 102i, respectively. Because no other nodes may remain to be visited in the tree 100 after arriving at node 102i, the DFS may finally terminate or conclude.

According to an example embodiment, a DFS may have only two types of moves, i.e., following a left or right branch, and these moves may occur in a definite order. As shown in FIG. 1, moves of the exemplary DFS of the tree 100 may be in a sequence of 104a-104i, where moves left 104a, 104b, 104d, and 104g may be indicated by solid directional lines, while moves right 104c, 104e, 104f, and 104h may be indicated by dashed directional lines.

In an example embodiment, a move left may be denoted by a 0 (zero) and a move left may be denoted by a 1 (one). A sequence of moves in terms of 0s and is may be a Dyck word of a binary tree, e.g., the tree 100.

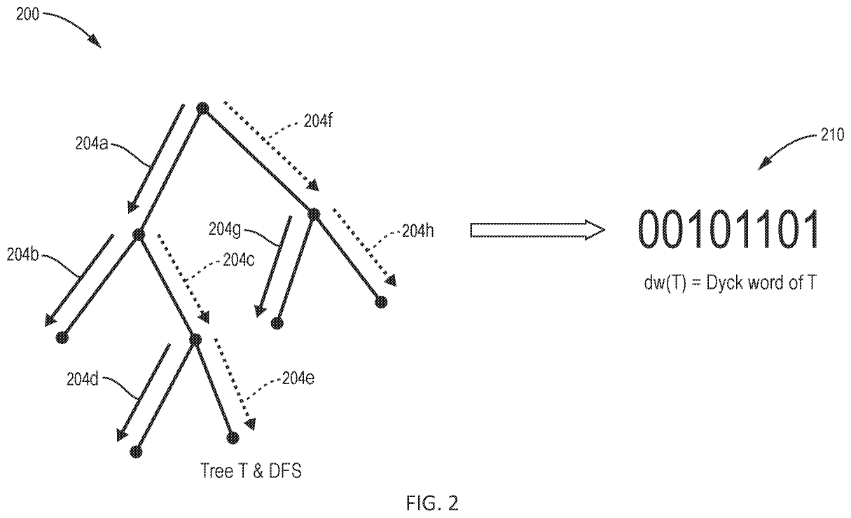

FIG. 2 illustrates an exemplary conversion from a tree 200 to a Dyck word 210 according to an example embodiment. As shown in FIG. 2, an exemplary DFS of the tree 200 may have a move sequence of left move 204a, left move 204b, right move 204c, left move 204d, right move 204e, right move 204f, left move 204g, and right move 204h. Converting the tree 200 into the Dyck word 210 may thus result in a 0s and is sequence of 00101101 (zero, zero, one, zero, one, one, zero, one), which may correspond to the move sequence of the exemplary DFS of the tree 200. In an example embodiment, a tree, e.g., the tree 200, may also be referred to as T and a Dyck word of the tree T, e.g., the Dyck word 210 of the tree 200, may also be referred to as dw(T).

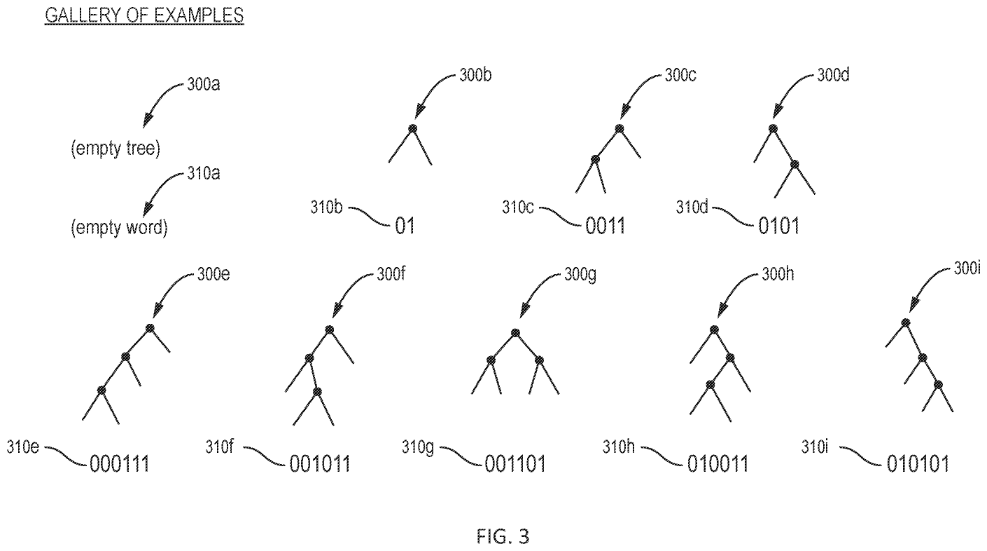

FIG. 3 illustrates exemplary trees 300a-300i and their corresponding Dyck words 310a-310i according to an example embodiment. In an example embodiment, is noted that when a tree, e.g., 300a, is empty, a corresponding Dyck word, e.g., 310a, may also be empty.

### Dyck Words and Tree Structure

In an example embodiment, it is noted that an exemplary DFS may first go left from a root of a tree, e.g., the root node 102a of the tree 100 (FIG. 1); search an entire left subtree, e.g., the nodes 102b-102f (FIG. 1); then go right from the root; and finally search an entire right subtree, e.g., the nodes 102g-102i (FIG. 1).

Thus, according to an example embodiment, if dw(L) and dw(R) are known, where L and R are left and right subtrees, respectively, of a tree T, then a Dyck word of the tree T may be derived using the following exemplary equation:

$$dw ( T ) = 0 dw ( L ) 1 dw ( R )$$

In another example embodiment, it is noted an exemplary DFS may first go left from a root of a tree, e.g., the root node 102a of the tree 100; search an entire left subtree, e.g., the nodes 102b-102f; then go right from the root; and finally search an entire right subtree, e.g., the nodes 102g-102i. Blurring the distinction between a tree T and its Dyck word, in an example embodiment, the tree T may be derived more succinctly using the following exemplary equation:

$$T = 0 L 1 R$$

Further, in yet another example embodiment, it is noted that in the above exemplary equation, L and R are each subwords (i.e., substrings or subsequences) of the tree T.

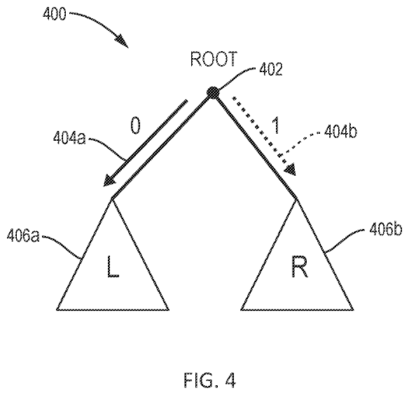

FIG. 4 illustrates an exemplary recursive form of a Dyck word (not shown) of a generalized tree 400, according to an example embodiment. As shown in FIG. 4, the tree 400 includes left subtree 406a and right subtree 406b. In an example embodiment, to derive the Dyck word of the tree 400, an exemplary DFS may first go left (indicated by a ‘0’ and solid directional line 404a) from root 402 of the tree 400, search the entire left subtree 406a, then go right (indicated by a ‘1’ and dashed directional line 404b) from the root 402, and finally search the entire right subtree 406b. According to another example embodiment, the subtrees 406a and 406b may be subwords of the tree 400.

### Subtrees

In an example embodiment, the principles described in the preceding section may also apply with respect to subtrees. According to another example embodiment, any given subtree may be a left or right child tree of a parent node. Thus, in an example embodiment, a Dyck word of a subtree having a parent node, relative to a Dyck word of a tree whose root is the parent node, may be a subword according to the below exemplary notation:

S∈S′

According to an example embodiment, the above exemplary notation may indicate that subtree S (which may be considered equivalent to a Dyck word) is a subword of parent tree S′. In another example embodiment, the above exemplary notation may be expanded and continue to S″, a parent of S′, and so on until an ultimate root node is reached, which root node may encompass an entire tree T, as shown in the below exemplary notation:

S∈S′∈S″∈ . . . ∈T

According to an example embodiment, in the above exemplary notation, each tree may be a subword of a next tree, which may also imply that S∈T. Put differently, in another example embodiment, a subword of a subword a tree may also be a subword of the tree itself. Thus, according to yet another example embodiment, a Dyck word of a subtree may be a subword (i.e., a substring or subsequence) of a Dyck word of a full tree that includes the subtree.

### Dyck Word Validation

In an example embodiment, an exemplary method for recognizing whether a binary string is a valid Dyck word may depend on relative quantities of symbols, e.g., 1s (ones) and 0s (zeroes), in the binary string.

### First Exemplary Dyck Word Validation Method

In an example embodiment, a first exemplary method for validating a Dyck word may leverage properties of DFS to determine whether a given string or sequence fulfills the below two exemplary requirements:
a) Reading the sequence left to right, a point is not reached where a running tally of 1s exceeds a running tally of 0s; and
b) A total quantity of 0s is equal to a total quantity of is in the sequence.

It is helpful to provide non-limiting examples of binary strings that are not Dyck words. For instance, a bit string 010110 may not be a Dyck word because its fifth symbol may be a point at which a running tally of is exceeds a running tally of 0s. It should be noted, however, that the second above exemplary requirement (total quantity of 0s equal to total quantity of Is) may still be met. As another example, a bit string 0011010 may not be a Dyck word because it may contain more 0s than Is, despite satisfying the first above exemplary requirement.

### Second Exemplary Dyck Word Validation Method

It should be noted that, in an example embodiment, the above two exemplary requirements can be formulated in terms of differences between quantities of 0s and Is, as given by the exemplary equations below:
a) (quantity of 0s at given index i)−(quantity of is at the index i)≥0
b) (total quantity of 0s)−(total quantity of Is)=0

According to another example embodiment, the above exemplary equations may also be referred to as “deltas” or, alternately, “weighted” deltas, as shown by the exemplary notations below:

$${delta}_{i} = ( quantity of 0 s at given index i ) - ( quantity of 1 s at the index i )$$

$${delta}_{n} = ( total quantity of 0 s ) - ( total quantity of 1 s )$$

Thus, in an example embodiment, a second exemplary method for validating a Dyck word may be succinctly formulated in terms of the below two exemplary requirements:

$${delta}_{i} \geq 0 \qquad a )$$

$${delta}_{n} = 0 \qquad b )$$

According to another example embodiment, in the above two exemplary requirements, n may be an index of a Dyck word's final symbol.

In an example embodiment, a delta may be updated iteratively according to the below exemplary equation:

$${delta}_{i + 1} = {delta}_{i} + \{ \begin{matrix}1 & if {w}_{i + 1} = 0 \\ 0 & if {w}_{i + 1} = 1\end{matrix}$$

According to another example embodiment, in the above exemplary equation, the Dyck word being validated may be in a form of a string or sequence ω₀ω₁ . . . ωₙ.

In an example embodiment, because an equation of ω→1−2ω may map 0→1 and 1→−1, the below exemplary equation may serve as a rule for updating a delta while reading a Dyck word:

$${delta}_{i + 1} = {delta}_{i} + ( 1 - 2 {ω}_{i + 1} )$$

Binary Trees with Leaf Data

In an example embodiment, a Dyck word and/or a leaf vector encoding may be generated or created from a binary tree with, e.g., nonnegative integer data (i.e., atoms) on its leaves (i.e., a decorated binary tree).

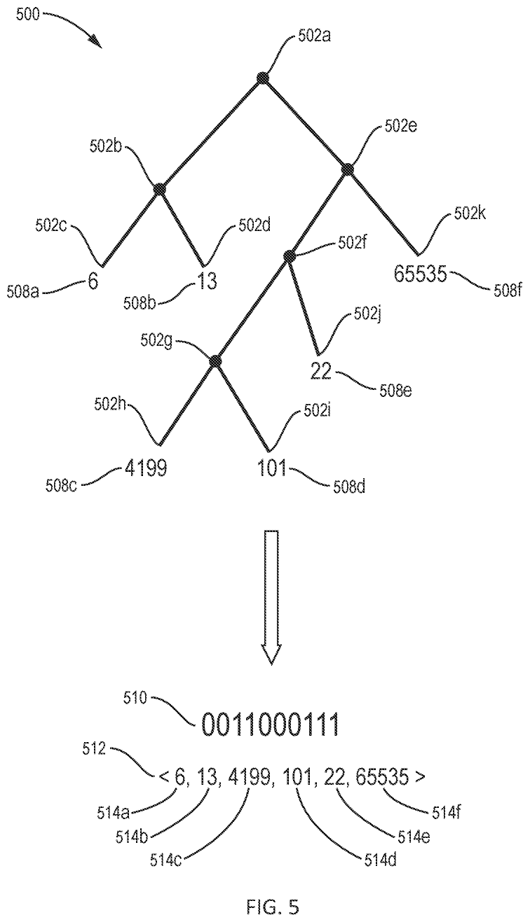

FIG. 5 illustrates an exemplary transformation or conversion from a tree, e.g., a nontrivial binary tree 500 with leaf data 508a-508f, to a Dyck word 510 and leaf vector encoding 512, according to an example embodiment. In an example embodiment, the tree 500 may include nodes 502a-502k, while leaf vector 512 may include components 514a-514f.

In an example embodiment, for a tree such as the tree 500, it may be desirable to encode the tree 500's shape, i.e., its Dyck word encoding 510, and its data 508a-508f. According to another example embodiment, the tree 500's data 508a-508f may be encoded in a manner that is geometrically and visually efficient and meshes well with the Dyck word encoding 510 of the tree 500's shape: the data 508a-508f may be arranged or structured in DFS order.

According to an example embodiment, decoding may proceed by using a sequence of the Dyck word 510 as instructions on how to rebuild or reconstruct the tree 500 via DFS. In another example embodiment, each time a leaf of the tree 500 is newly generated, a next unused component of the leaf vector 512 may be placed at the newly generated leaf. For instance, when first leaf 502c of the tree 500 is generated, first component 514a (i.e., corresponding to the data 508a) of the leaf vector 512 may be placed at the generated first leaf 502c. Similarly, when second leaf 502d of the tree 500 is generated, second component 514b (i.e., corresponding to the data 508b) of the leaf vector 512 may be placed at the generated second leaf 502d.

In an example embodiment, when performing an exemplary DFS, the only move for going deeper into a tree from a given point may be a move denoted symbolically by 0, i.e., a move left, such as 104a (FIG. 1), 204a (FIG. 2), or 404a (FIG. 4). Thus, according to another example embodiment, if a next move for the exemplary DFS is not to go deeper into the tree, i.e., the next move is not a 0 (i.e., a left move), then the exemplary DFS may presently be at a leaf.

According to an example embodiment, while parsing or interpreting a Dyck word, if a next symbol is not 0—i.e., it is 1—or no symbols remain in the Dyck word, then a current position in a tree corresponding to the Dyck word may be at a leaf of the tree.

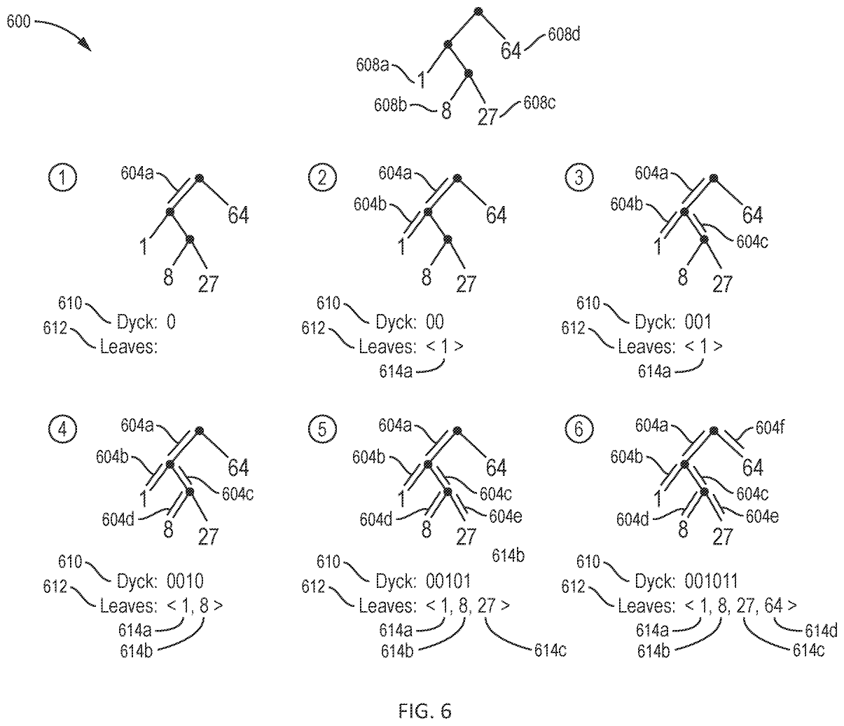

FIG. 6 illustrates exemplary steps 1-6 of an encoding process for a tree 600 with data 608a-608d according to an example embodiment. As shown in FIG. 6, at step 1, left move 604a may result in a 0 symbol being appended to the Dyck word 610, but because a leaf node may not be encountered, no component may be added to leaf vector 612.

Next, at step 2, further left move 604b may result in another 0 symbol being added to the Dyck word 610, and, because the left move 604b may encounter a leaf node, this may result in component 614a (i.e., corresponding to the data 608a) being added to the leaf vector 612.

At step 3, right move 604c may result in a 1 symbol being added to the Dyck word 610, but because a leaf node may not be encountered, no component may be added to the leaf vector 612.

In turn, at step 4, left move 604d may result in a 0 symbol being added to the Dyck word 610, and, because the left move 604d may encounter a leaf node, this may result in component 614b (i.e., corresponding to the data 608b) being added to the leaf vector 612.

At step 5, right move 604e may result in a 1 symbol being added to the Dyck word 610, and, because the right move 604e may encounter a leaf node, this may result in component 614c (i.e., corresponding to the data 608c) being added to the leaf vector 612.

Finally, at step 6, further right move 604f may result in another 1 symbol being added to the Dyck word 610, and, because the right move 604f may encounter a leaf node, this may result in component 614d (i.e., corresponding to the data 608d) being added to the leaf vector 612.

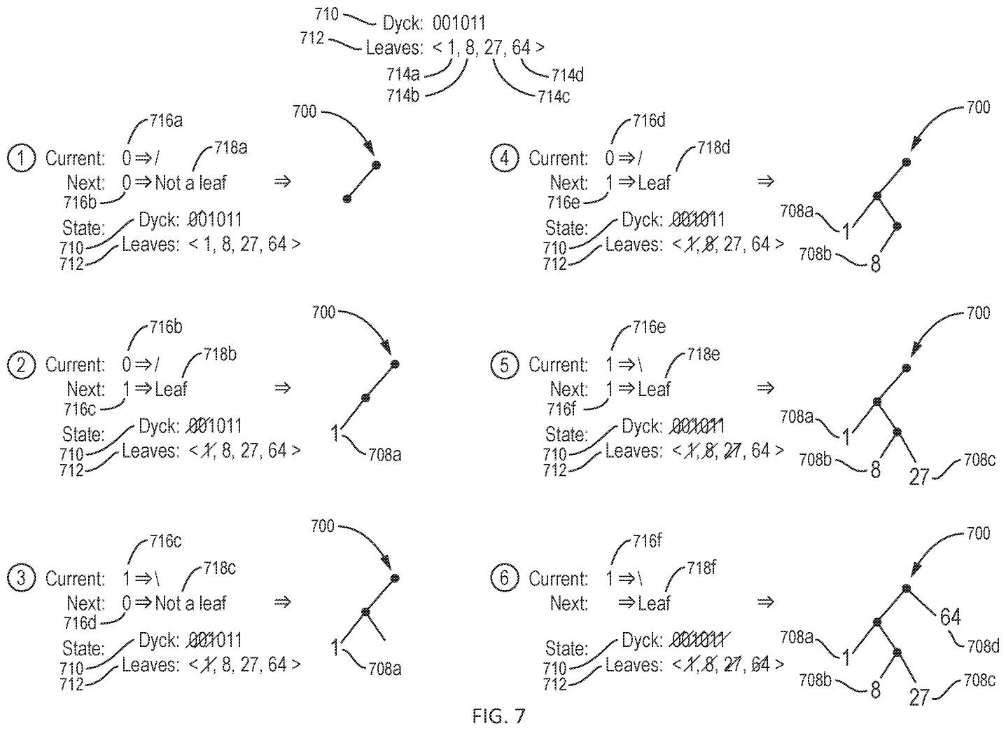

FIG. 7 illustrates exemplary steps 1-6 of a decoding process for a Dyck word 710 and leaf vector 712 with components 714a-714d according to an example embodiment. As shown in FIG. 7, at step 1, a current symbol 716a of the Dyck word 710 may be a 0, thus resulting in a left branch 718a being added to in-progress tree 700. A next symbol 716b of the Dyck word 710 may also be a 0, meaning that the left branch 718a may not include a leaf node (i.e., because a next symbol is present in the Dyck word and the next symbol does not result in a right branch).

Next, at step 2, a current symbol 716b of the Dyck word 710 may also be a 0, thus resulting in another left branch 718b being added to the tree 700. A next symbol 716c of the Dyck word 710 may be a 1, meaning that the left branch 718b may include a leaf node (not shown); thus, data 708a—corresponding to the first component 714a of the leaf vector 712—may be included at the leaf node of the left branch 718b.

To continue, at step 3, a current symbol 716c of the Dyck word 710 may be a 1, thus resulting in a right branch 718c being added to the tree 700. A next symbol 716d of the Dyck word 710 may be a 0, meaning that the right branch 718c may not include a leaf node.

In turn, at step 4, a current symbol 716d of the Dyck word 710 may be a 0, thus resulting in a left branch 718d being added to the tree 700. A next symbol 716e of the Dyck word 710 may be a 1, meaning that the left branch 718d may include a leaf node (not shown); thus, data 708b—corresponding to the second component 714b of the leaf vector 712—may be included at the leaf node of the left branch 718d.

Then, at step 5, a current symbol 716e of the Dyck word 710 may be a 1, thus resulting in a right branch 718e being added to the tree 700. A next symbol 716f of the Dyck word 710 may also be a 1, meaning that the right branch 718e may include a leaf node (not shown); thus, data 708c—corresponding to the third component 714c of the leaf vector 712—may be included at the leaf node of the right branch 718e.

Finally, at step 6, a current symbol 716f of the Dyck word 710 may be a 1, thus resulting in a right branch 718f being added to the tree 700. The Dyck word 710 may have no next symbol remaining, meaning that the right branch 718f may include a leaf node (not shown); thus, data 708d—corresponding to the fourth (and final) component 714d of the leaf vector 712—may be included at the leaf node of the right branch 718f.

### Subtree Numbering

In an example embodiment, a tree may be assigned a numeric identifier, for instance, 1 (one). According to another example embodiment, a left subtree and a right subtree of the tree may similarly be assigned numeric identifiers, for instance, 2 (two) and 3 (three), respectively. It should be noted that the left subtree's identifier can be defined by the formula 2=2*1; likewise, the right subtree's identifier can be defined by the formula 3=2*1+1.

According to an example embodiment, the preceding formulas may be concrete examples of a more general principle. That is, in another example embodiment, if a tree T has a numeric identifier A (also referred to as its “axis” identifier) assigned to it, then the identifier A may be used in the below two exemplary general formulas:

$$2 A , 2 A + 1$$

The above two exemplary general formulas may define numeric identifiers for the tree T's left and/or right subtrees, respectively, if any.

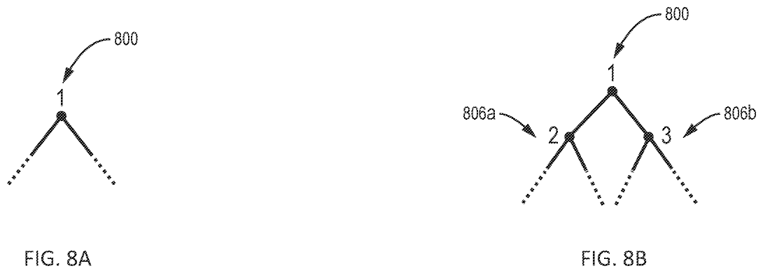

FIG. 8A illustrates an exemplary tree 800 according to an example embodiment. As shown in FIG. 8A, the tree 800 may be assigned a numeric identifier of 1 (one).

FIG. 8B illustrates the exemplary tree 800 of FIG. 8A, including left subtree 806a and right subtree 806b, according to an example embodiment. As shown in FIG. 8B, the left subtree 806a may be assigned a numeric identifier of 2 (two), while the right subtree 806b may be assigned a numeric identifier of 3 (three).

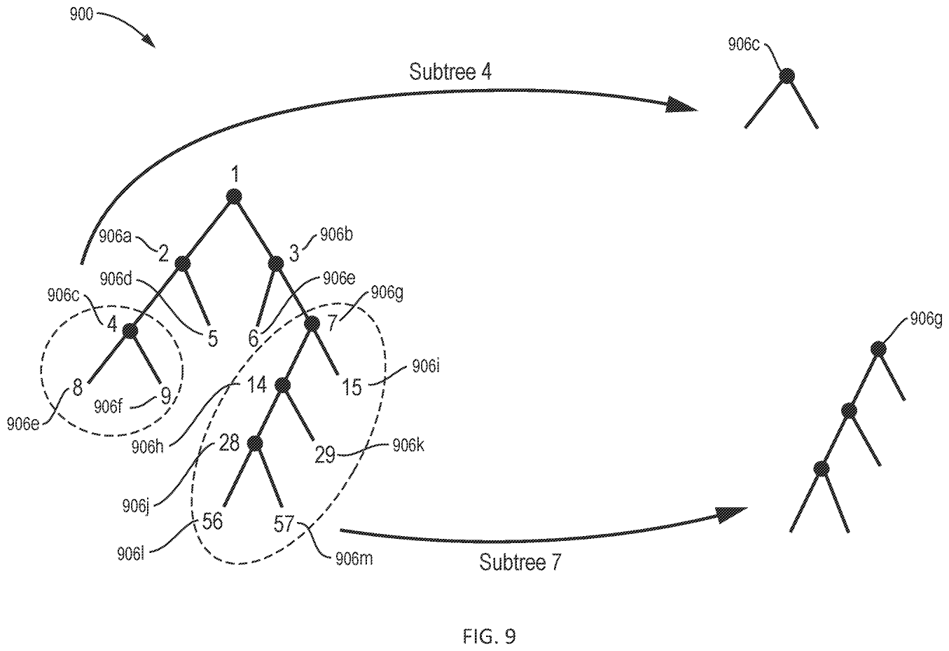

FIG. 9 illustrates an exemplary tree 900 with subtrees 906a-906m according to another example embodiment. As shown in FIG. 9, for instance, subtree 906c may have an axis (A) identifier of 4 (four), while its left subtree 906e and right subtree 906f may have identifiers of 8 (eight) and 9 (nine) respectively. According to an example embodiment, the identifier of the left subtree 906e may follow the exemplary general formulas above, in that 8=2*4. Likewise, in another example embodiment, the identifier of the right subtree 906f may follow the exemplary general formulas above, in that 9=2*4+1.

### Path to a Subtree

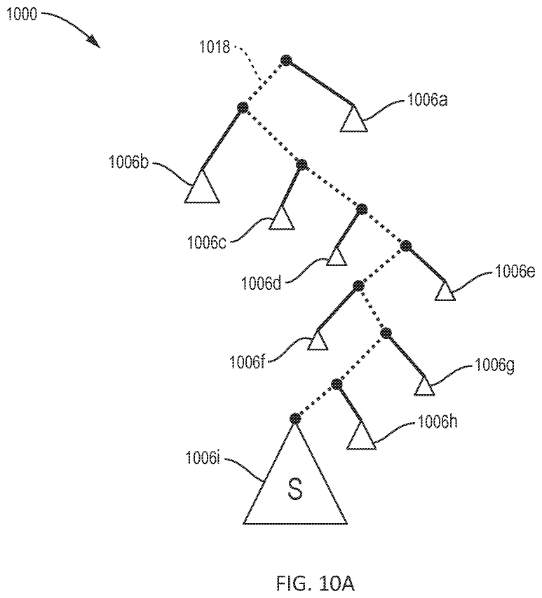

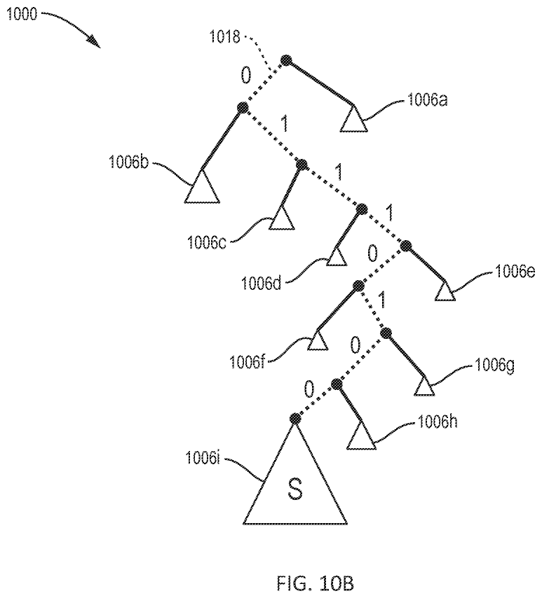

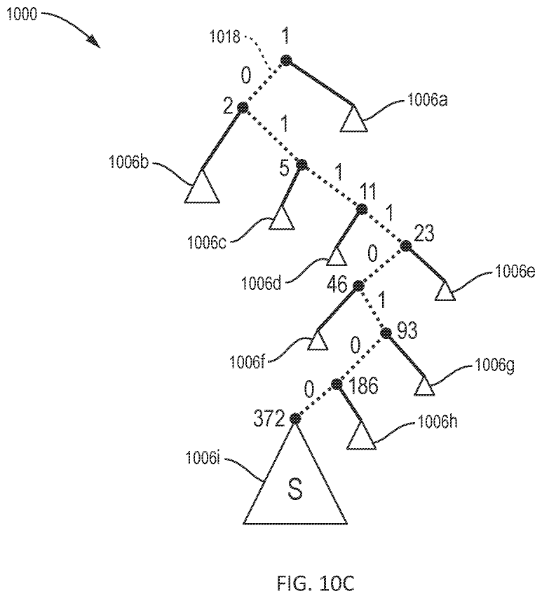

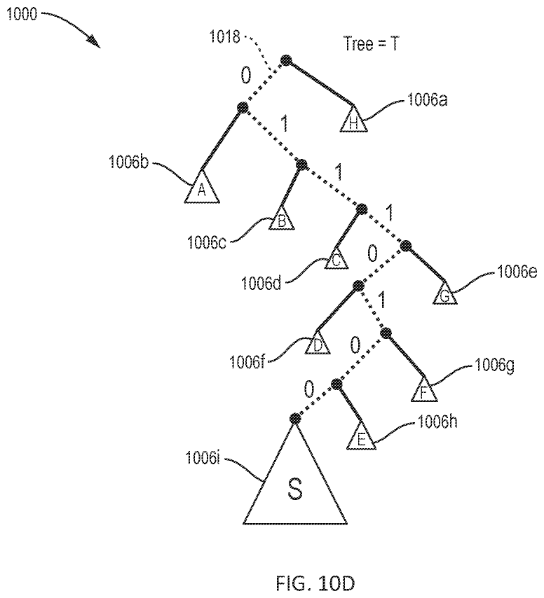

FIG. 10A is a generalized diagram of an exemplary tree 1000, e.g., a binary tree, having subtrees 1006a-1006i, according to an example embodiment. As shown in FIG. 10A, details of the subtrees 1006a-1006h may be abstracted and replaced with a Δ symbol. In an example embodiment, a path to a given subtree S, e.g., the subtree 1006i, may be depicted in FIG. 10A as dashed line 1018.

It should be noted that, in an example embodiment, the path 1018 can be described or represented by a sequence or string of 0 and/or 1 symbols, in a manner similar to Dyck words. According to another example embodiment, the path 1018 may be represented by the following exemplary sequence, also referred to as a “path word”:

$$path = 01110100$$

In an example embodiment, the above exemplary path word (i.e., for the path 1018) may be used to yield a binary representation of the subtree S's, e.g., the subtree 1006i's, axis (A) identifier, according to the below exemplary formula:

$$path = 01110100$$

$$↓$$

$$A = 0 b 101110100$$

$$= {2}^{8} + {2}^{6} + {2}^{5} + {2}^{4} + {2}^{2}$$

$$= 372$$

According to an example embodiment, a left move, which may correspond to a 0 symbol, may multiply the axis identifier by 2. But, in another example embodiment, multiplying by 2 may be the same as appending a 0 to the right in binary. In yet another example embodiment, a right move may be similar, because its symbol may be 1, but “multiply-by-2-then-add 1” in binary may be the same as appending a 1 to the right.

In an example embodiment, when reading a Dyck word of a full tree T, e.g., the tree 1000, the symbols of the path word (i.e., for the path 1018) may all occur, in order, in the Dyck word, as seen in the below exemplary notation:

$$T = 0 A 1 B 1 C 10 D 100 S 1 E 1 F 1 G 1 H$$

$$path = 01110100$$

According to another example embodiment, the above exemplary result may occur due to one or more properties of an exemplary DFS.

FIG. 10B illustrates the exemplary tree 1000 of FIG. 10A annotated with a path word sequence for the path 1018 according to an example embodiment.

FIG. 10C illustrates the exemplary tree 1000 of FIG. 10A where each subtree 1006a-1006h is annotated with its respective axis (A) identifier (e.g., in base ten), according to an example embodiment.

FIG. 10D illustrates the exemplary tree 1000 of FIG. 10A where each subtree 1006a-1006h is labeled, according to an example embodiment.

In an example embodiment, a tree T and/or its subtree(s) may have one or more of the following exemplary properties:
a) Each subtree may have an axis identifier A.
b) A given axis identifier's binary symbols, excluding any leading 1, may describe a path of left/right moves to a given subtree.
c) A given path may be contained, in order, within a Dyck word of the full tree T.

### Exemplary Method for Subtree Access

In an example embodiment, parameters for an exemplary method, e.g., a linear method, for accessing or reaching a target subtree S may be specified as follows:
a) Inputs:
   i. Decorated binary tree T: (Dyck word, leaf vector)
   ii. Axis identifier A
b) Output:
   i. Decorated binary subtree S: (Dyck word, leaf vector) such that S is a subtree of T at axis identifier A

According to another example embodiment, the exemplary subtree access method may include the following steps. Initially, a “path” to the target subtree S may be determined or calculated from binary symbols of the input axis identifier A. The exemplary subtree access method may include following the determined path. However, to follow the path it may first be necessary to construct or generate a tree structure—i.e., based on the input Dyck word-up to that point according to, e.g., a DFS.

In an example embodiment, if a given move in the path is a left move, then the left move may be made in conjunction with a DFS creating a left branch of the tree, because the DFS may create each left branch prior to creating each right branch. However, if the given move is a right move, then, before making the right move, it may be necessary to wait until the DFS has parsed or processed a portion of the input Dyck word corresponding to any remaining left portion of the tree.

According to an example embodiment, the exemplary subtree access method may determine how long to wait based on properties of Dyck words and by using a “local count” mechanism as follows. For a given node in the tree structure, if a next move of the path is a right move, but the next DFS operation is to create a left branch or segment, then a “mismatch” may occur, and the node may be considered or designated as a “conflict” node. When a conflict node is encountered, the exemplary subtree access method may create or initialize a local count variable. Creating a left branch from the conflict node may then cause a value of the local count variable to be incremented by 1 (one). While the DFS is constructing a left subtree from the conflict node, the value of the local count variable may remain greater than or equal to 1 (one). After the DFS fully generates the left subtree—i.e., once the DFS exits the left subtree—the value of the local count variable may be equal to 1 (one). In turn, when a next symbol of the path aligns or matches with a next symbol of the input Dyck word—i.e., after the DFS exits the left subtree and both the next symbol of the path and the next symbol of the input Dyck word are 1 (one)—a subtraction operation may cause the value of the local count variable to reach 0 (zero). This may allow the exemplary subtree access method to resume proceeding along the path to the target subtree S.

In an example embodiment, once all symbols in the path are exhausted or processed, this may result in the exemplary subtree access method reaching or arriving at the target subtree S. Further, according to another example embodiment, a subtree local count variable may be used to detect when the target subtree S is exited or fully traversed. When a value of the local count variable reaches a negative value, e.g., −1 (negative one), this may indicate that traversal of the target subtree S is complete. During traversal of the target subtree S, each symbol of the input Dyck word and each component of an input leaf vector that are processed may be included in a corresponding output Dyck word and output leaf vector, respectively.

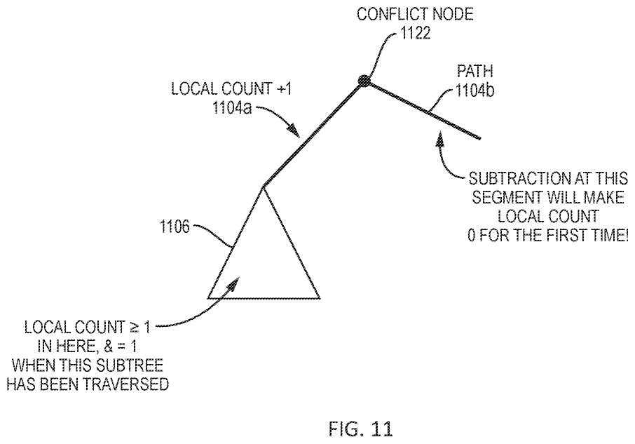

FIG. 11 illustrates an exemplary conflict node 1122 with a corresponding local count variable (not shown) according to an example embodiment. As shown in FIG. 11, a left move 1104a from the conflict node 1122 may cause a value of the local count variable to be incremented by 1 (one). In an example embodiment, while a left subtree 1106 from the conflict node 1122 is being visited, the value of the local count variable may be greater than or equal to 1 (one). Upon completing traversal of the left subtree 1106, the value of the local count variable may be equal to 1 (one). According to another example embodiment, a subsequent right move 1104b from the conflict node 1122 may result in a subtraction operation being performed, which in turn may cause the value of the local count variable to be 0 (zero).

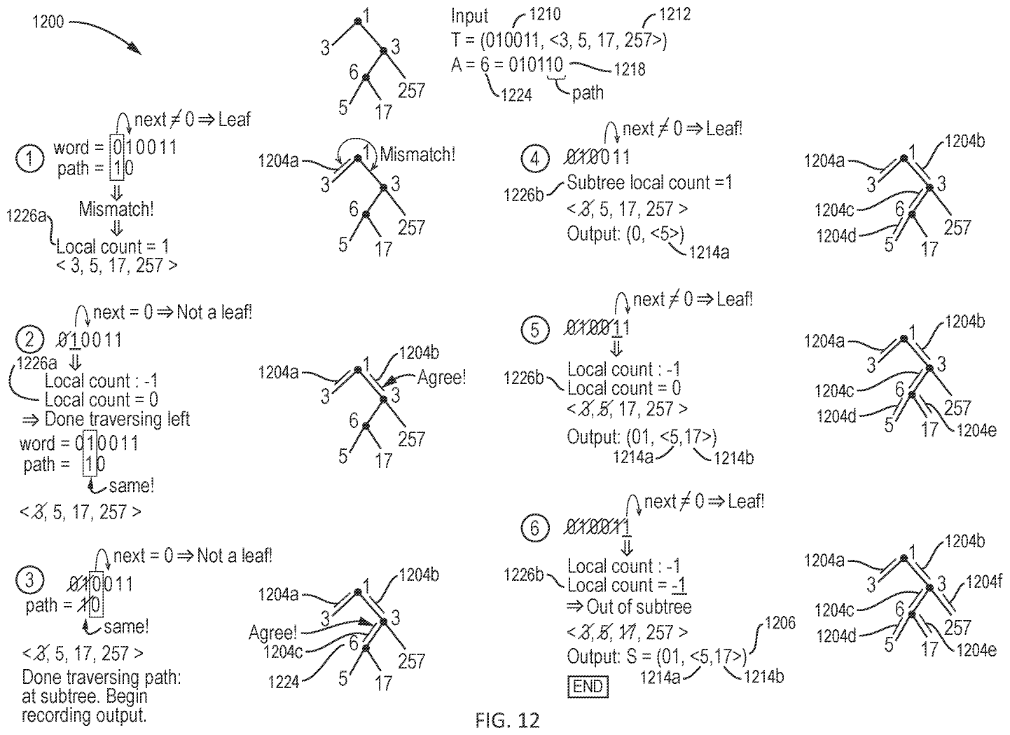

FIG. 12 illustrates exemplary steps 1-6 of a method 1200 for accessing a target subtree 1206 according to an example embodiment. As shown in FIG. 12, the method 1200 may take as inputs a tree T, e.g., a decorated tree, having an associated Dyck word 1210 and leaf vector 1212, as well as an axis identifier 1224 associated with the target subtree 1206. In an example embodiment, based on the axis identifier 1224, the method 1200 may determine or calculate a path 1218.

According to an example embodiment, at step 1, the method 1200 may determine that a mismatch exists between a first symbol of the Dyck word 1210—which may correspond to a left move 1204a—and a first move of the path 1218. Upon identifying the mismatch, the method 1200 may then create a conflict local count variable 1226a with an initial value of 1 (one). Moreover, the method 1200 may wait to proceed with the first move of the path 1218.

In another example embodiment, at step 2, the method 1200 may determine that a match or agreement exists between a second symbol of the Dyck word 1210—which may correspond to a right move 1204b—and a first move of the path 1218. Upon identifying the match, the method 1200 may then decrement the value of the conflict local count variable 1226a so that the value is equal to 0 (zero). A 0 value for the conflict local count variable 1226a may cause the method 1200 to determine that it should proceed with the first move of the path 1218.

According to an example embodiment, at step 3, the method 1200 may again determine that a match exists—this time between a third symbol of the Dyck word 1210 (which may correspond to a left move 1204c) and a second (and final) move of the path 1218. Upon identifying the match, the method 1200 may proceed with the second and final move of the path 1218. Because the move 1204c may lead to a subtree having the axis identifier 1224 associated with the target subtree 1206, the method 1200 may further determine that the target subtree 1206 has been reached.

In another example embodiment, at step 4, having arrived at the target subtree 1206, the method 1200 may create a subtree local count variable 1226b with an initial value of 1 (one). The method 1200 may then proceed with move 1204d, which may correspond to a fourth symbol of the Dyck word 1210. In turn, the method 1200 may include in its output (i) the fourth symbol of the Dyck word 1210 and (ii) a leaf vector component 1214a corresponding to the fourth symbol.

According to an example embodiment, at step 5, the method 1200 may decrement the value of the subtree local count variable 1226b so that the value is equal to 0 (zero). The method 1200 may then proceed with move 1204e, which may correspond to a fifth symbol of the Dyck word 1210. In turn, the method 1200 may further include in its output (i) the fifth symbol of the Dyck word 1210 and (ii) a leaf vector component 1214b corresponding to the fifth symbol.

In another example embodiment, at step 6, the method 1200 may again decrement the value of the subtree local count variable 1226b so that the value is equal to −1 (negative one). A−1 value for the subtree local count variable 1226b may indicate that the method 1200 has exited the target subtree 1206. The method 1200 may then proceed with move 1204f, which may correspond to a sixth—and final—symbol of the Dyck word 1210. In turn, having finished processing the entire Dyck word 1210, the method 1200 may determine to conclude at step 6.

### Encoding of Subtree Access

In an example embodiment, one or more rules for execution of an exemplary subtree access method above may be described as a series of one or more constraints, e.g., polynomial constraints.

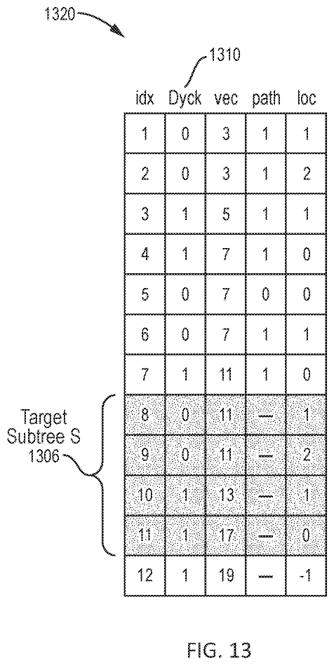

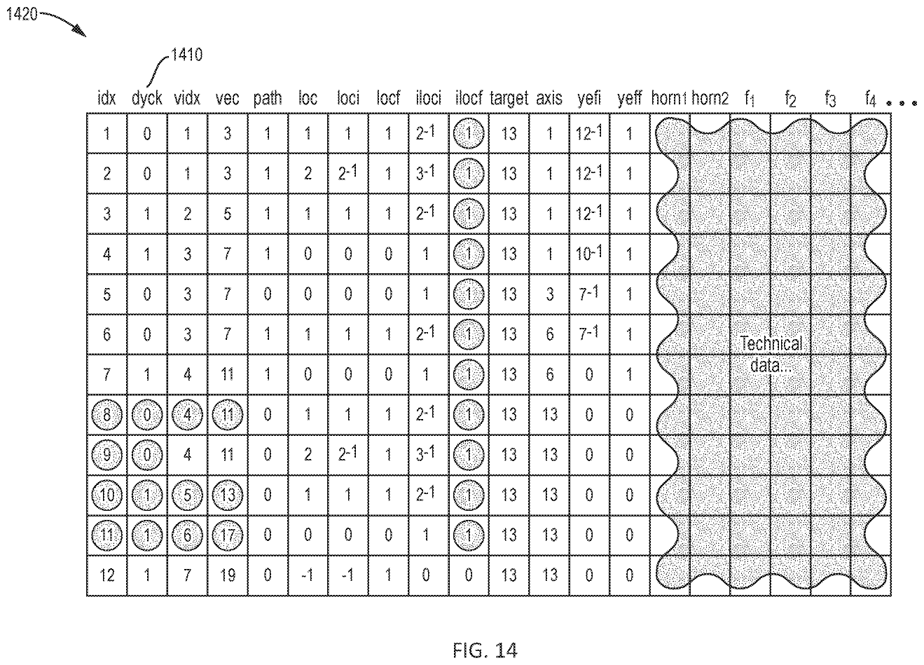

FIG. 13 illustrates an exemplary table or trace 1320 of a Dyck encoding 1310 according to an example embodiment. As shown in FIG. 13, a portion of the table/trace 1320 may correspond to a target subtree 1306. In an example embodiment, the table/trace 1320 may be used to prove correct tree traversal. According to another example embodiment, one or more additional columns may be added to the table/trace 1320.

FIG. 14 illustrates an exemplary table or trace 1420, e.g., an extended table/trace, of a Dyck encoding 1410 according to another example embodiment. In an example embodiment, FIG. 14 may depict a more detailed trace, compared to FIG. 13, such as by including additional columns.

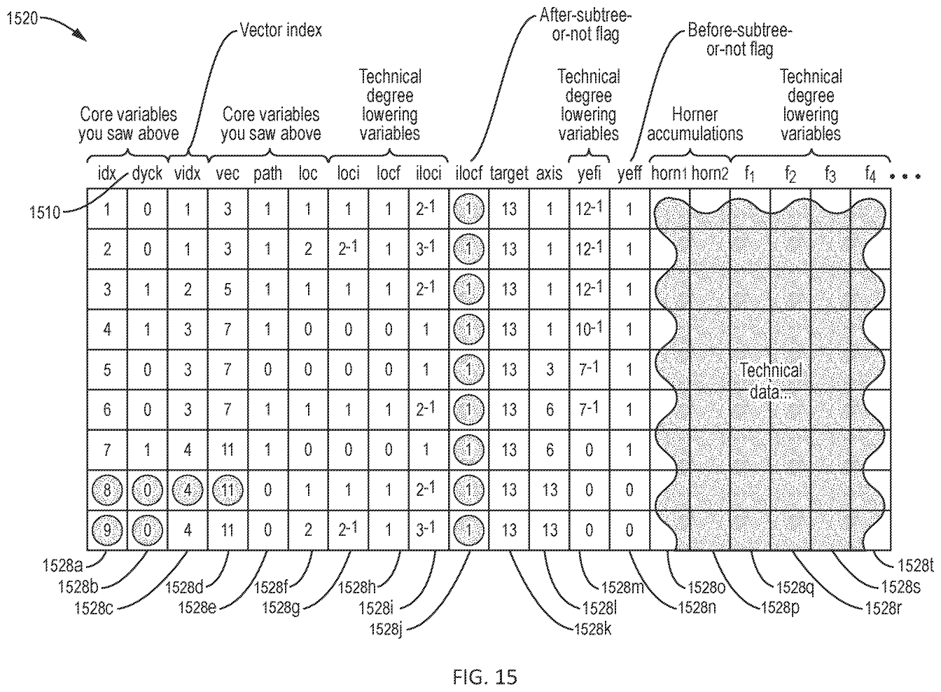

FIG. 15 illustrates an exemplary table or trace 1520, e.g., an extended table/trace, of a Dyck encoding 1510 with descriptions for columns 1528a-1528t according to an example embodiment. In an example embodiment, FIG. 15 may add descriptions to the columns of FIG. 14. Take specific note of pair (ilocf 1528j, yetf 1528n). Extra variables may be designed to make this pair equal (1,0) when in a target subtree. Blue is and yellow 0s combine to highlight green indices and green Dyck letters. A technical construction involving column “horn1” 1528o may extract this info from the table/trace 1520. Blue 1s, yellow 0s, and red Dyck letters may also combine to make purple vector indices and purple vector components. (Red Dyck letters may be a first letter in the target subtree and is in the subtree.) A similar construction with column “horn2” 1528p may remove this data from the table/trace 1520.

According to an example embodiment, one or more constraints may be used with the exemplary table/trace 1520 of FIG. 15 to verify that the table/trace 1520 represents a proper execution of an exemplary subtree access algorithm. Below is an exemplary set of such constraints, for non-limiting example:

$${idx}^{′} = idx$$

$${idx}^{′} = idx$$

$$path ( 1 - path ) = 0$$

$$locf = loc \cdot loci$$

$$loc \cdot ( locf - 1 ) = 0$$

$$loci ( locf - 1 ) = 0$$

$$f 1 = yetf \cdot locf$$

$$yetf \cdot [ locf \cdot ( {axis}^{′} - axis ) + ( 1 - locf ) ( {axis}^{′} - ( 2 axis + path ) ) ] + ( 1 - yetf ) \cdot ( {axis}^{′} - axis ) = 0$$

$$etc .$$

### Exemplary System Architecture

Certain embodiments may provide higher-performance representations for potentially incomplete binary trees and/or an innovative cryptographic proof system architecture.

Nock is a Turing-complete virtual machine (VM) specification based on combinatorial calculus. At present, Nock includes twelve operations, referred to by their ordinals (e.g., Nock 1, Nock 2, etc.). Nock is used as a layer for a general-purpose operating system (OS) known as Urbit®, where Nock computations may be run as interpreted bytecode. Urbit provides functionality such as I/O (input/output) drivers, a persistence layer, and a peer-to-peer networking substrate, among other examples. A data structure that Nock uses to represent both data and code is potentially incomplete binary trees, e.g., potentially incomplete ordered binary trees. Nock's computational model may be defined as a set of one or more reduction rules on potentially incomplete binary trees, where a given tree contains Nock operations at specific vertices of the tree combined with data to which the operations apply. Executing a Nock program may include applying reduction rule(s) to a given tree (which may represent code). Among the present Nock operations is a tree modification operation, and this operation may be used to create/modify state and/or perform function calls. Thus, an encoding used by a system implementing a Nock VM to model computation (as in the case of Urbit) may require efficient performance characteristics for an operation such as tree modification. Current Nock VM implementations inside Urbit may utilize a pointer-based system, but as mentioned hereinabove, both array-based and pointer-based systems may be naïve and/or inefficient at representing potentially incomplete binary trees. Embodiments may provide a high-performance encoding that can drastically increase performance at every level of a system (networking, persistence, and I/O, among other examples). Any interpreter, e.g., a Nock interpreter, whether in the context of Urbit or not, may benefit from techniques provided by embodiments.

The Nock VM specification may be selected as a model of computation to encode. A memory model may also be used to model data access and/or modification. For instance, as mentioned hereinabove, one existing approach is to model a concept of RAM reads and writes in a fashion similar to memory used by a Turing machine. However, such an approach may come with significant costs of constraint size and conceptual complexity, which can give rise to a proof system that is inefficient and harder to reason about. It is important to note that Nock's notion of memory access diverges from the traditional Turing machine model, such as with regard to data layout and access. In particular, because there is no structured data in Nock that is not a potentially incomplete binary tree, there is no way for a program to perform arbitrary pointer-based memory reads and writes, only tree traversal and modification. Modeling traditional RAM in a Nock VM based on, e.g., a proof system, while never making use of such a memory model, in practice may lead to incurring unnecessary performance costs.

Certain embodiments may provide a more efficient proof system that takes advantage of extra strictness offered by a data/memory model, such as the Nock data/memory model. Because a particular Dyck word may not only encode a structure of a given tree “at rest,” but may also correspond to linear steps of a depth-first traversal (i.e., DFS) of the tree, some embodiments may provide an approach that includes writing constraints that encode tree traversal and/or modification invariants directly. Further, because a Dyck word can be decoded, e.g., linearly, for instance by accessing only a current and next leaf node to determine a next step in an exemplary decoding process, certain embodiments may include a system for generating proofs about computations, e.g., Nock computations, while offering immense performance benefits by, for instance, simultaneously modeling memory access, e.g., Nock specific memory access, without paying larger costs of generalized memory access. In some embodiments, leaf data may be an element within a finite field itself or may be represented using a higher-level encoding that may, for instance, take arbitrarily large leaf data and encode it as a tree of field elements.

In an example embodiment, a ZKP may be generated for a particular electronic transaction in a blockchain network. A procedure may also be performed on-chain to validate that the ZKP has been generated for the transaction. However, actual computation of logic for the transaction may be performed off-chain. Accordingly, the only process taking place on-chain may be the verification of proof of the transaction. In another example embodiment, a proof of a transaction processed off-chain may be a zero-knowledge VM (ZKVM) proof.

Some embodiments may track data from an on-chain state that is incorporated into a given transaction, e.g., on a blockchain network. The tracking may include explicit dependency tracking, which may be based on UTXO semantics, for non-limiting example. Such tracking of data from an on-chain state may allow for certain embodiments to process multiple transactions in parallel. For instance, in an example embodiment, multiple proofs may be merged together and aggregated to form a single block. According to another example embodiment, in a blockchain network, performing useful work to find or mine a next block may include forming ZKPs of an aggregation of transactions into a block. In this way, concepts of transaction generation and inclusion in a block may be merged with an actual blockchain mining process. Further, in yet another example embodiment, a verification process that aggregates individual transaction proofs may also introspect into input and/or output data. Such an introspection technique may ensure that child proofs that are aggregated are proofs of fixed computation that validate a particular set of constraints. The technique may also enable verifying that outputs conform to particular rules, such as the outputs are not conflicting, for non-limiting example.

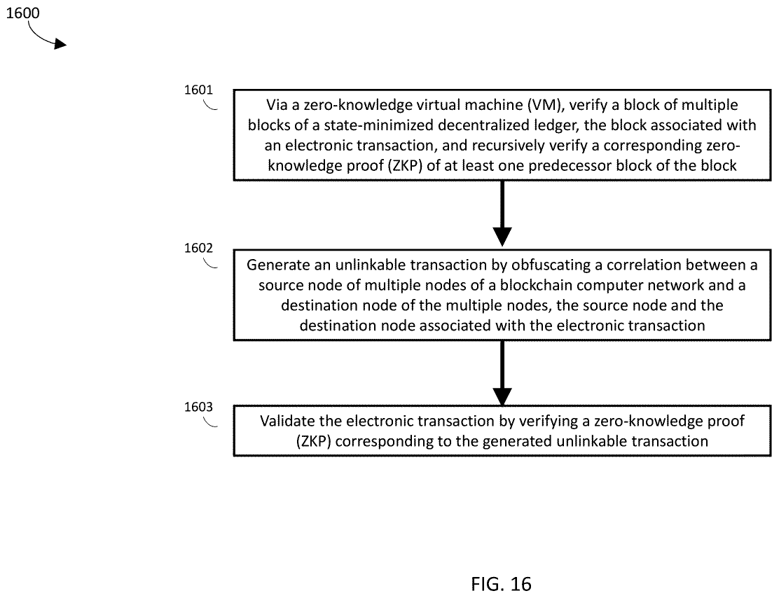

FIG. 16 is a flow diagram of an exemplary computer-based system/method 1600 for state minimization and unlinkable transactions according to an embodiment. The system/method 1600 begins by 1601 via a zero-knowledge VM, verifying a block of multiple blocks of a state-minimized decentralized ledger based on a block header of the block and at least one ZKP of the multiple blocks and recursively verifying a corresponding ZKP of at least one predecessor block of the block. The block is associated with an electronic transaction. The state-minimized decentralized ledger is configured as a dynamic cryptographic accumulator implementing a decentralized ledger protocol. The system/method 1600 continues by generating 1602 an unlinkable transaction by obfuscating a correlation between a source node of multiple nodes of a blockchain computer network and a destination node of the multiple nodes. The source node and the destination node are associated with the electronic transaction. The system/method 1600 then validates 1603 the electronic transaction by verifying a ZKP corresponding to the generated unlinkable transaction. The ZKP is configured to attest to correctness of the generated unlinkable transaction and satisfaction of smart contract logic associated with a digital wallet.

Aspects of the system/method 1600 of FIG. 16 may be as described in Allen et al., “EDEN—a practical, SNARK-friendly combinator VM and ISA,” Cryptology ePrintArchive, 2023, pp. 1-34 and Allen et al., “Airwalk: Accessible Decentralized Ledgers with State-Minimization and Unlinkable Smart Transactions,” pp. 1-41, both of which are herein incorporated by reference in their entirety and further attached hereto as Appendices A and B, respectively.

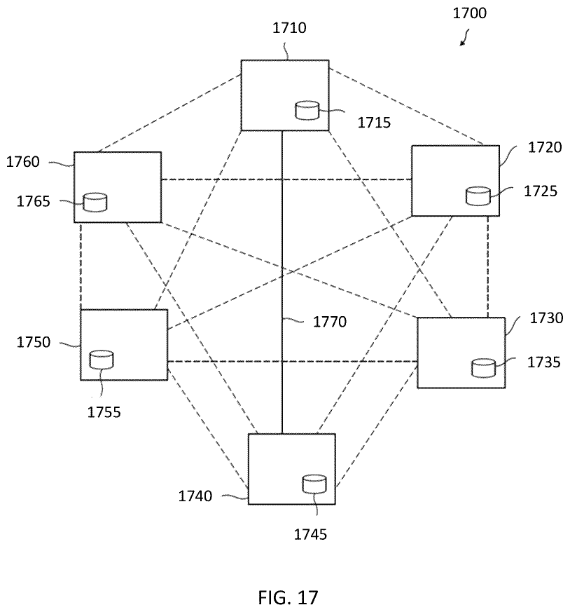

FIG. 17 is a block diagram of an example embodiment of a blockchain network 1700, also referred to interchangeably herein as a distributed ledger network 1700, that may be accessed according to an example embodiment. The blockchain network 1700 is a distributed ledger P2P network and may be valuable because this network enables trustworthy processing and recording of transactions without the need to fully trust any user (e.g., person, entity, program, and the like) involved in the transactions, reducing the need for trusted intermediaries to facilitate the transaction. Existing applications use the distributed ledger network 1700 to transfer and record, in the form of blockchain based records, movement of tokens. Such blockchain based records form a cryptographically secured backlinked list of blocks.

The distributed ledger network 1700 includes multiple computing devices configured as nodes 1710, 1720, 17170, 1740, 1750, 1760 of the distributed ledger network 1700. Each node 1710, 1720, 17170, 1740, 1750, 1760 locally stores and maintains a respective identical copy 1715, 1725, 17175, 1745, 1755, 1765 of the blockchain ledger in memory communicatively coupled to the node. The nodes exchange messages within the distributed ledger network 1700 to update and synchronize the ledger stored and maintained by each node. The nodes may also execute decentralized applications (dApps), such as via smart contracts, for processing the messages. A message transmission 1770 from the node 1710 to the node 1740 may be used to exchange a token in the distributed ledger network 1700 as shown in FIG. 17. The dotted lines between each set of nodes in the distributed ledger network 1700 indicate similar transmissions that may be exchanged between any other set of nodes in the distributed ledger network 1700. The messages may include a confirmed transfer for recording data associated with the token being transferred, such as a blockchain public key for each of the one or more parties participating in the transfer.

Continuing with FIG. 17, according to an example embodiment, the blockchain network 1700 may be an Ethereum network; however, it should be understood that the blockchain network 1700 may also be any suitable blockchain network known to those of skill in the art. Ethereum is a decentralized network of computers with two basic functions: (i) a blockchain that can record transactions and (ii) a VM, that is, an Ethereum Virtual Machine (EVM), that can produce smart contracts. Because of these two functions, Ethereum is able to support dApps. These dApps are built on the existing Ethereum blockchain, piggybacking off of its underlying technology. In return, Ethereum charges developers for the computing power in their network, which can only be paid in Ether (ETH), the only inter-platform currency. Depending on its purpose, a dApp may create ERC-20 (Ethereum Request for Comments issue number 20) tokens to function as a currency. According to an example embodiment, FTs disclosed herein may be ERC-20 tokens or any other suitable FT known in the art.

The code of a smart contract may be uploaded on the EVM, which may be a universal runtime compiler or browser, to execute the smart contract's code. Once the code is on the EVM, the code may be the same across each Ethereum node to be run to check whether one or more condition(s) are met, such as a condition for secure possession of respective shard(s) of a cryptographic key by corresponding node(s) of a blockchain computer network.

Ethereum has a long history of developed standards. For example, ERC-20 is a standard that defines a set of six functions that other smart contracts within the Ethereum computer-implemented ecosystem can understand and recognize. ERC-20 is a protocol standard and in order to be ERC-20 compliant, the functions need to be included in the token's smart contract. ERC-20 outlines a specific list of rules that a given Ethereum-based token has to deploy, simplifying the process of programming the functions of tokens on Ethereum's blockchain. These include, for instance, how to transfer a token (by the owner or on behalf of the owner), such as may be employed for transferring FTs of a buyer, and how to access data (e.g., name, symbol, supply, and/or balance) concerning the token.

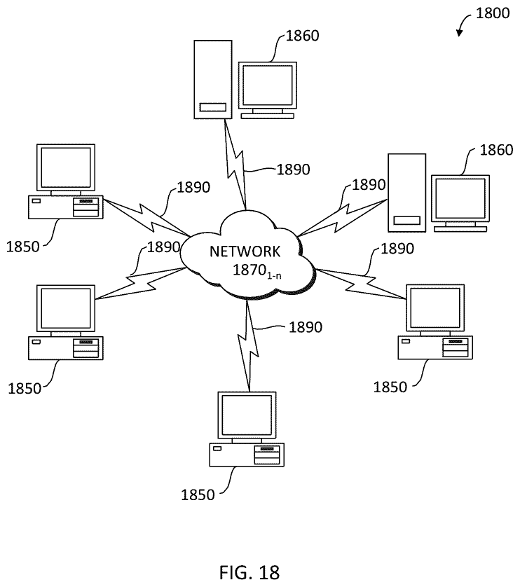

An example embodiment may be implemented in a software, firmware, and/or hardware environment. FIG. 18 illustrates one such example digital processing environment in which embodiments of the present disclosure may be implemented. Client computer(s)/device(s) 1850 and server computer(s)/device(s) 1860 provide processing, storage, and I/O devices executing application programs and the like.

The client computer(s)/device(s) 1850 may be linked 1890 directly or through communications network(s) 1870₁₋ₙ to other computing devices, including other client computer(s)/device(s) 1850 and server computer(s)/device(s) 1860. A communication network 1870 may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Moreover, a communication network 1870 may also be a virtual private network (VPN) or an out-of-band (OOB) network or both. In addition, a communication network 1870 may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, the client computer(s)/device(s) 1850 may include the nodes shown in FIG. 17, which may run user applications that enable a user to communicate with an application to determine whether a user meets a work requirement. A blockchain network may be configured on each user device 1710, 1720 (FIG. 17) to store tokens. The client computers 1750 (FIG. 17) of the computer-based system/method 1600 (FIG. 16) may be configured with a trusted execution environment (TEE) or Trusted Platform Module (TPM), where the application may be run and digital assets and/or tokens may be stored.

Referring again to FIG. 18, the server computer(s)/device(s) 1860 of the computer-based system/method 1600 may be configured to include a server that that executes an application. The server computer(s)/device(s) 1860 may not be separate server computers, but instead may be part of a cloud service. For another example, the server computer(s)/device(s) 1860 or the client computer(s)/device(s) 1850 may include the peer computing devices (nodes) 1710, 1720, 17170, 1740, 1750, 1760 of the distributed blockchain ledger 1700 of FIG. 17, which use smart contracts to execute and record transactions implemented via tokens.

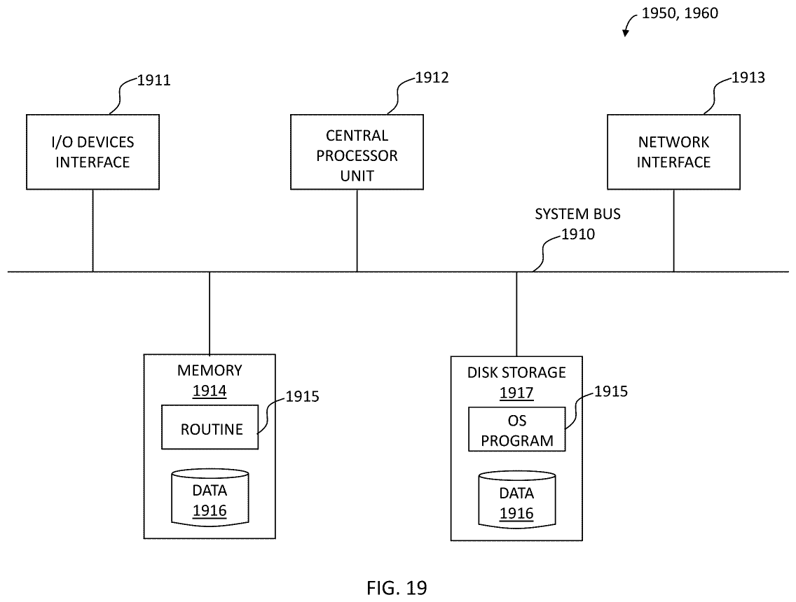

FIG. 19 is a block diagram of any internal structure of a computing/processing node (e.g., the client computer(s)/device(s) 1850 or server computer(s)/device(s) 1860) in the processing environment 1800 of FIG. 18, which may be used to facilitate displaying audio, image, video, and/or data signal information. Each computer/device 1850, 1860 in FIG. 18 may contain a system bus 1910, where a bus is a set of actual or virtual hardware lines used for data transfer among components of a computer or processing system. The system bus 1910 may essentially be a shared conduit that connects different elements of a computer system (e.g., processor, disk storage, memory, I/O ports, etc.), thereby enabling transfer of data between elements or components.

Continuing with FIG. 19, attached to the system bus 1910 is an I/O device interface 1911 for connecting various input and output devices (e.g., keyboard, mouse, touch screen interface, displays, printers, speakers, audio inputs and outputs, video inputs and outputs, microphone jacks, etc.) to a computer/device 1850, 1860. A network interface 1913 may allow a computer/device to connect to various other devices attached to a network, e.g., the network 1870 of FIG. 18. A memory 1914 may provide volatile storage for computer software instructions 1915 and data 1916 used in some embodiments to implement software modules/components of the system/method 1600 (FIG. 16).

The software components 1915, 1916 of the system/method 1600 (e.g., device integrity attestation and authentication software components, multinetwork digital asset controller, software components of the blockchain network 1700 (FIG. 17), a minimax recursive algorithm, TPM/TEE, blockchain Layer 1 VM, encoder/decoder, arbiter, oracle/ML oracle/VM oracle, wallet interface, applets, authentication site, cybersecurity controller, service applications, and the like) described herein may be configured using any suitable programming language known in the art, including any high-level, object-oriented programming (OOP) language, such as Python or Solidity. The computer-based system may include instances of processes that enable execution of transactions and recordation of such transactions. It should be understood that the terms “transaction” and “exchange” are herein used interchangeably, when used within a context of digitally transferring items of value, such as digital assets, collateral assets, and/or collateral tokens, among entities associated with a blockchain network, e.g., the blockchain network 1700 (FIG. 17). The system/method 1600 may also include instances of a scoring engine and/or encoders/decoders, which can be implemented by, e.g., a server 1860 and/or a client 1850 that communicates with the server 1860, using, for example, SSL (secure sockets layer), HTTPS (Hypertext Transfer Protocol Secure), or any other suitable protocol known in the art.

In an example mobile implementation, a mobile agent implementation of embodiments may be provided. A client-server environment may be used to enable mobile services using a network server, e.g., a server 1860. It may use, for example, the Extensible Messaging and Presence Protocol (XMPP) protocol, or any other suitable protocol known to those of skill in the art, to tether a device authentication engine/agent 1915 on a user device 1850 to a server 1860. The server 1860 can then issue commands to the user device 1850 on request. The mobile user interface framework used to access certain components of the system/method 1600 (FIG. 16) may be based on, e.g., XHP, Javalin, and/or WURFL (Wireless Universal Resource File), or other suitable known framework(s), interface(s), and/or combinations thereof. In another example mobile implementation for the iOS operating system and its corresponding API (application programming interface), the Cocoa Touch API may be used to implement the client-side components 1915 using Objective-C or any other suitable known high-level OOP language that adds Smalltalk-style messaging to the C programming language.

A disk storage 1917 may provide non-volatile storage for the computer software instructions 1915 (equivalently “OS program”) and the data 1916 may be used to implement embodiments of the system/method 1600. The system may include disk storage accessible to a server computer 1860. The server computer may maintain secure access to records associated with the system/method 1600. CPU 1912 may also be attached to the system bus 1910 and provide for execution of computer instructions. In one example embodiment, the CPU 1912 is a secure cryptoprocessor implemented as a dedicated microprocessor configured to execute a zero-knowledge verifier system according to principles of the present disclosure. The cryptoprocessor may be specialized to execute cryptographic algorithms within hardware to support the zero-knowledge verifier system. Functions include such things as accelerating encryption algorithms that verify compliance of encoded rules related to a NFT asset, enhanced tamper, and intrusion detection, enhanced data, key protection and security enhanced memory access and I/O to facilitate transactions across multiple blockchain systems.

In some embodiments, the processor routines 1915 and the data 1916 may be computer program products. For example, aspects of the system/method 1600 may include both server-side and client-side components.

In other embodiments, authenticators/attesters may be contacted via, e.g., instant messaging applications, video conferencing systems, VoIP (voice over IP) systems, email systems, etc., all of which may be implemented, at least in part, in the software 1915, 1916. Further, in yet other embodiments, an authentication engine/agent interfacing with the system/method 1600 may be implemented as an API, executable software component, and/or integrated component of the OS configured to authenticate users on a TPM executing on a client device 1850.

In one embodiment, an example multinetwork digital asset control system is implemented as an embedded VM, preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module (HSM) with security measures providing failsafe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning.

According to an example embodiment, the software implementations 1915, 1916 are computer program products, e.g., an application and smart contracts (generally referenced as 1915), including a computer-readable medium capable of being stored on the storage device 1917, which provides at least a portion of the software instructions for the computer-based system/method 1600. Executing instances of respective software components of the system/method 1600, such as instances of the application and/or smart contracts, may be implemented as computer program products 1915, and may be installed by any suitable software installation procedure, as is well known in the art. In another embodiment, at least a portion of the system software instructions 1915 may be downloaded over a wired and/or wireless connection via, for example, a browser SSL session or through an app (whether executed from a mobile or other computing device). In other embodiments, the system/method 1600 software components 1915 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art). Such carrier medium or signals may provide at least a portion of the software instructions for the computer-based system/method 1600.

An example embodiment includes device code executed in a TEE or TPM. A TEE or TPM is a hardware environment that runs instructions and stores data outside a main OS of a device. This protects sensitive code and data from malware or snooping with purpose-built hardware governed by an ecosystem of endorsements, beginning with a device manufacturer. The system may perform checks on the TEE or TPM, such as executing BIOS (Basic I/O System) checks, to verify that folders (e.g., wallets) stored in the TEE/TPM have not been altered by malicious actors.

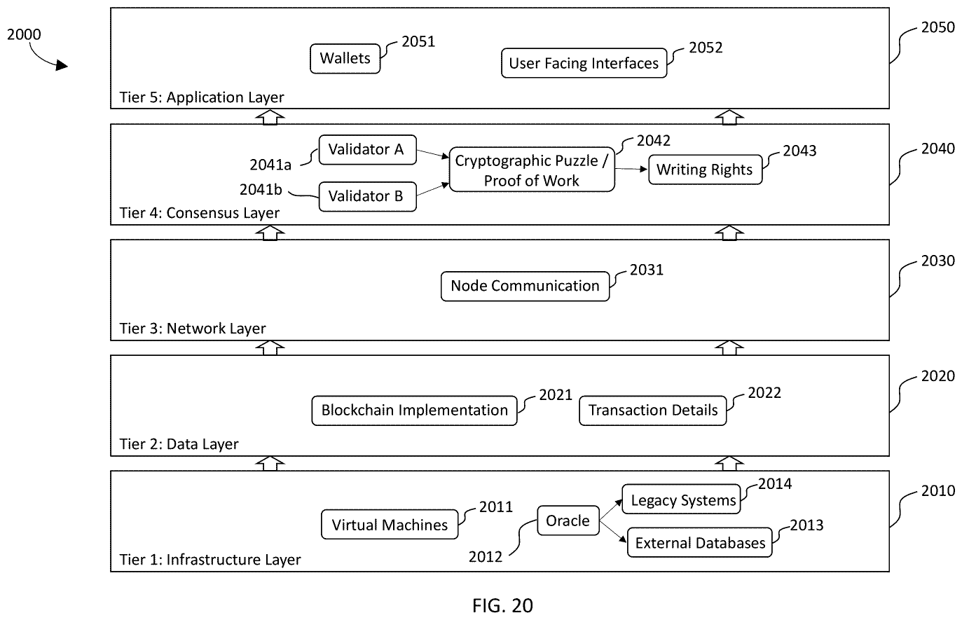

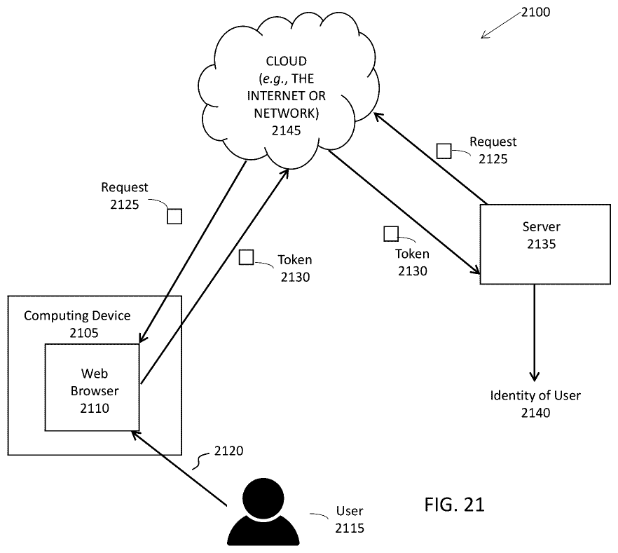

FIG. 20 is a block diagram showing exemplary blockchain layers 2000 according to an embodiment. The blockchain layers 2000 may include infrastructure (tier 1) layer 2010, data (tier 2) layer 2020, network (tier 3) layer 2030, consensus (tier 4) layer 2040, and application (tier 5) layer 2050. The infrastructure layer 2010 may be a hardware layer and may include one or more VM(s) 2011 and/or one or more oracles 2012. A VM 2011 may provide a runtime environment for transaction execution in the blockchain. In an embodiment, a VM 2011 may be, for example, stack-based and may enable untrusted code to be executed by a global P2P network of computers. An oracle 2012 may provide a third-party service that connects smart contracts executing on the blockchain with off-chain data sources. For instance, an oracle 2012 may query, verify, and/or authenticate one or more external data sources for the computer-based system/method 1600 (FIG. 16). According to an example embodiment, external data sources may include, e.g., one or more legacy systems 2014 and/or databases 2013.

According to an example embodiment, an oracle node architecture, e.g., oracle 2012, may be provided to serve ML models for smart contracts on a blockchain. Example smart contract technology may be implemented by any suitable Web3 blockchain system known in the art, such as Ethereum, Cardano®, Solana, BNB (Build N' Build) Smart Chain, Casper™ Kaleido, or Fantom.

The oracle architecture may be referred to as a “ML oracle.” The ML oracle is useful to smart contract developers who want to incorporate ML models into their smart contracts. For example, a smart contract may distribute funds based on an algorithm, and the algorithm may include a ML model that forecasts sales of a product for a given week. The smart contract may invoke an inference call to a model on the ML oracle to obtain the forecast. As a further example, there are generative arts where the generative ML model may be an integral part of an artwork. Interaction with the model to generate new images may be part of a viewing experience. One well-known ML model type used by generative art is a generative adversarial network (GAN). Using the ML oracle, the ML model may become part of an NFT, thereby enabling an interactive viewing experience.

In an example embodiment, a smart contract may request an inference call to a ML model by identifying an ML model to call, such as by providing a hash value, and an input to the model. According to one such embodiment, a model file may be uploaded to, e.g., IPFS (InterPlanetary File System) or any other suitable known storage system, by a dApp developer and a model server may download the model file, e.g., using the hash value. For the ML model server to be generic enough to serve a wide range of models, it may also take as an input parameter a model type, e.g., PyTorch, TensorFlow, scikit-learn, or any other suitable known model type, as well as an input and output specification. The input may be data directly received from the calling smart contract, or it may be received indirectly via, e.g., an IPFS URI (Uniform Resource Identifier) or any other suitable identifier known to those of skill in the art. Similarly, the output may be sent back to the smart contract, or it may be uploaded to any suitable known storage system, including, but not limited to IPFS, and the, e.g., URI, may be sent to the smart contract. For instance, a forecasting model may use the direct I/O method. An indirect I/O method employing a known storage system such as IPFS may be commonly used by computer vision/imaging models, among other examples.

In an example embodiment, the system/method 1600 may include a VM, e.g., VM 2011, with a blockchain oracle, e.g., oracle 2012.

Continuing with FIG. 20, the data layer 2020 may interface with the infrastructure layer 2010 and may include blockchain implementation 2021 and transaction details 2022. A blockchain is a decentralized, massively replicated database (distributed ledger), where transactions are arranged in blocks, and placed in a P2P network. The blockchain implementation 2021 may include a data structure represented, for example, as a linked list of blocks, where transactions are ordered. The blockchain implementation 2021's data structure may include two primary components-pointers and a linked list. Pointers are variables that refer to a location of another variable, and a linked list is a list of chained blocks, where each block has data and pointers to the previous block. Each block may contain a list of transactions that happened since a prior block. The transaction details 2022 may contain information about transactions occurring on the blockchain.

The network layer 2030 may interface with the data layer 2020 and may also be referred to as a P2P layer or propagation layer. One purpose of the network layer 2030 may be to facilitate node communication 2031, such that nodes can discover each other and can communicate, propagate, and synchronize with each other to maintain a valid current state of the blockchain. A distributed P2P network, e.g., the network layer 2030, may be a computer network in which nodes are distributed and share the workload of the network to achieve a common purpose. Nodes in the network layer 2030 may carry out the blockchain's transactions.

The consensus layer 2040 may interface with the network layer 2030 and may ensure that blocks are ordered, validated, and guaranteed to be in the correct sequence. A set of agreements between nodes in a distributed P2P network may be established by the consensus layer 2040. The agreements result in consensus protocols or algorithms, which correspond to rules that nodes follow in order to validate transactions and create blocks in accordance with those rules. To validate a transaction, a validator, e.g., validator 2041a or validator 2041b, may perform a consensus algorithm, such as proof of work 2042 or any other suitable algorithm known in the art. Performing the consensus algorithm may involve expending computational resources to solve a cryptographic puzzle 2042. After being validated according to a consensus algorithm, a transaction may be written to the blockchain through a process of writing rights 2043.

The application layer 2050 may interface with the consensus layer 2040 and may include customized applications and services, such as electronic wallets 2051. Further, the application layer 2050 may include (not shown): smart contracts, chaincode, and/or dApps. The application layer 2050 may also include applications utilized by end users to interact with the blockchain. Such applications may be, e.g., one or more user facing interfaces 2052. Further, such applications may include, for example (not shown): scripts, APIs, and/or frameworks.

FIG. 21 shows an example of a user identification system 2100 according to an embodiment. A user 2115 interacts via user input 2120 with a website displayed via a web browser 2110 running on computing device 2105, such as clicking an advertisement on the displayed website. The interaction is communicated to server (e.g., token server) 2135. For example, a transparent pixel or script may be placed on the displayed website to communicate the interaction to the server 2135.

An application executing on the server 2135 determines whether the user 2115 is a software robot or a person user by issuing a request 2125 to web browser 2110 to produce a token. The request 2125 is sent over a network 2145. In response to request 2125, web browser 2110 produces a token 2130 on computing device 2105. The token 2130 is sent to the server 2135 over network 2145. The application executing on server 2135 determines (e.g., using a computational challenge) a computational cost of producing the token 2130. In some embodiments, the computational cost of producing the token 2130 is based on the time taken to produce the token 2130. Based on the computational cost of producing the token 2130, the application on server 2135 determines (deciphers) whether the user 2115 is a software robot or a person user. In some embodiments, proving the computational cost of producing the token 2130 at the computing device 2105 is performed by an independent third party, rather than the application executing on server 2135.

An application that determines whether the user 2115 is software robot or a person user may also exist locally on the computing device 2105. In this embodiment, it would not be necessary to send request 2125 or token 2130 over a network 2145.

In some embodiments, the request 2125 is issued in response to particular user engagement in the web browser 2110 and based on user engagement metrics, including mouse movements by the user. The request 2125 can also be issued in response to an elapsed period of time or issued by a web service.

In some embodiments, the application on server 2135 of FIG. 21 calculates a confidence score and metrics associated with whether the user 2115 operating computing device 2105 is at least in part by a software robot or a person user. Once the application on server 2135 determines whether user 2115 is a software robot or a person user, the application on server 2135 returns the identity of the user 2140 and a calculated confidence score, which is associated with a likelihood of whether computing device 2105 is being operated by a software robot or a person user. Thus, the calculated confidence score indicates a confidence value regarding the user identification. The confidence score helps the relying party determine a measure of confidence about the identity of the user 2140.

The confidence score can be based on many different factors. One factor is the computational cost of the produced token 2130. If the proven computation cost is low (below a threshold value), the confidence score may be increased. Further, if computing device 2105 is a server, the computational cost is higher than if the computing device 2105 is an individual machine, and thus the confidence score may be increased. The confidence score may be based on the time it took computing device 2105 to produce the token 2130. For example, longer times (e.g., above a time threshold) for producing token 2130 may be associated with a higher likelihood that the identity of the user 2140 is a software robot and a lower likelihood that the identity of the user 2140 is a person user. In another embodiment, the confidence score is increased if the computing device 2105 includes a TPM.

According to some embodiments, produced token 2130 is captured in a cookie. In an embodiment, the captured produced token and the computational cost of the captured produced token 2130 are time sensitive and expire after a period of time. Captured cookies can sign cookies generated in the future thus, building up proof of whether the web browser 2110 running on computing device 2105 is being operated by a person user or a bot. The building up of proof results in a longer block chain, making it increasingly difficult for a web browser running on a machine that is operated by a bot to continue to produce tokens.

In some embodiments, the confidence score may be calculated to further consider the confirmed purchase activities of the user. The score may increase when determined that a user is a verified purchaser who previously completed an online purchase. The proof of a user being an online purchaser, such as a retrieved proof of purchase cookie associating the user's identity to an entry in a database of confirmed purchases may increase the confidence score. For example, a retrieved proof of purchase cookie associating the user's identity particularly to a persistent entry in a block chain database of confirmed purchases may further increase the confidence score. That is, the trusted confirmation of the user as a verified purchaser may be associated with a higher likelihood (confidence) that the identity of the user is a person (rather than a software robot).

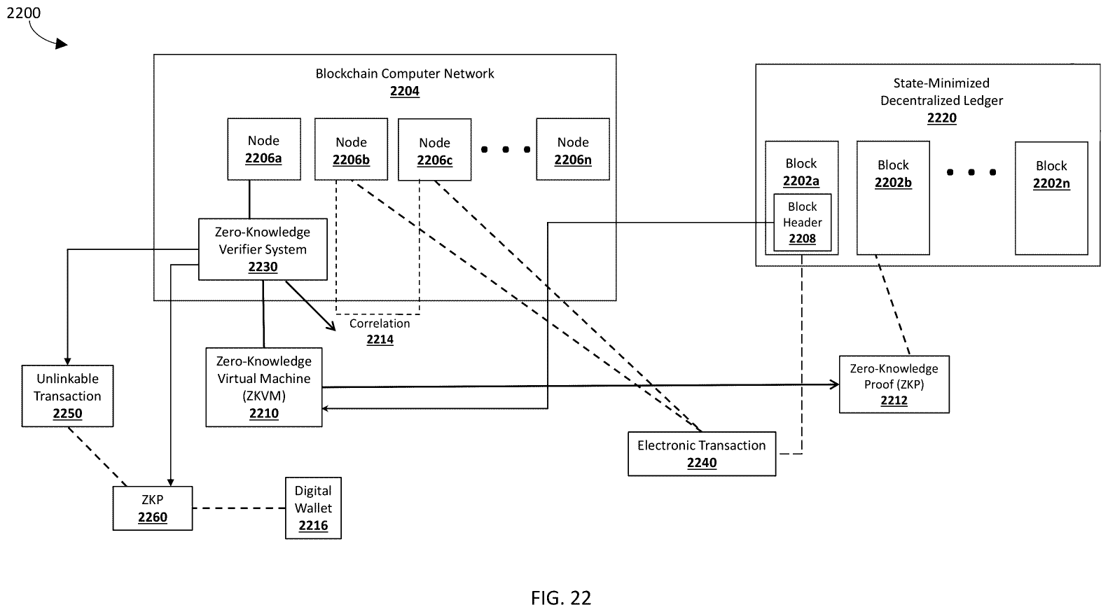

FIG. 22 is a block diagram of an example embodiment of a system 2200 for state minimization and unlinkable transactions. The system 2200 includes a zero-knowledge virtual machine (ZKVM) 2210, a state-minimized decentralized ledger 2220, and a blockchain computer network 2204. The state-minimized decentralized ledger 2220 may include multiple blocks 2202a-n and may be configured as a dynamic cryptographic accumulator (not shown) implementing a decentralized ledger protocol. The blockchain computer network 2204 may have multiple nodes 2206a-n. A node, e.g., node 2206a, may be configured to execute a zero-knowledge verifier system 2230. The zero-knowledge verifier system 2230 may be configured to, via the ZKVM 2210, verify a block, e.g., block 2202a, of the multiple blocks 2202a-n based on a block header 2208 of the block 2202a and at least one ZKP (not shown) of the multiple blocks 2202a-n. The block 2202a may be associated with an electronic transaction 2240. The zero-knowledge verifier system 2230 may be further configured to, via the ZKVM 2210, recursively verify a corresponding ZKP 2212 of at least one predecessor block, e.g., 2202b, of the block 2202a. The zero-knowledge verifier system 2230 may be further configured to generate an unlinkable transaction 2250 by obfuscating a correlation 2214 between a source node, e.g., 2206b, of the multiple nodes 2206a-n and a destination node, e.g., 2206c, of the multiple nodes 2206a-n. The source node 2206b and the destination node 2206c may be associated with the electronic transaction 2240. The zero-knowledge verifier system 2230 may be further configured to validate the electronic transaction 2240 by verifying a ZKP 2260 corresponding to the generated unlinkable transaction 2250. The ZKP 2260 may be configured to attest to correctness of the generated unlinkable transaction 2250 and satisfaction of smart contract logic (not shown) associated with a digital wallet 2216.

Aspects of the system 2200 of FIG. 22 may be as described in Allen et al., “EDEN—a practical, SNARK-friendly combinator VM and ISA,” Cryptology ePrintArchive, 2023, pp. 1-34 and Allen et al., “Airwalk: Accessible Decentralized Ledgers with State-Minimization and Unlinkable Smart Transactions,” pp. 1-41, both of which are herein incorporated by reference in their entirety and further attached hereto as Appendices A and B, respectively.

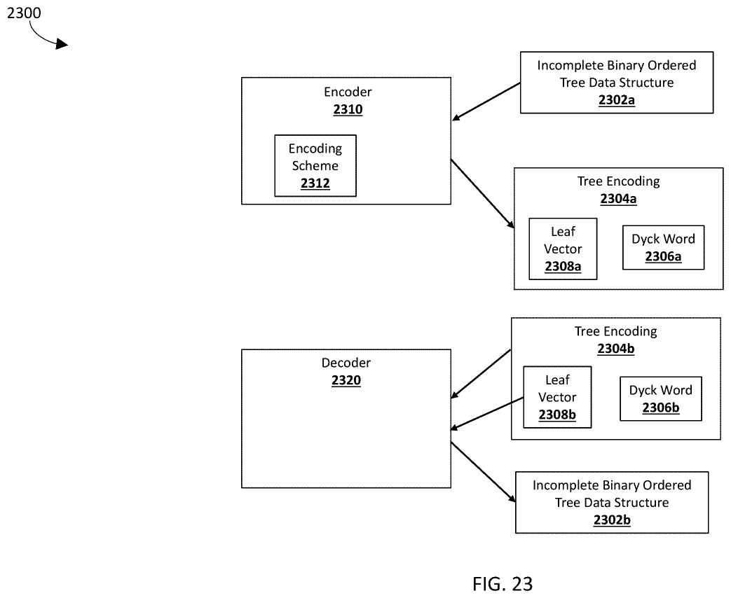

FIG. 23 is a block diagram of an example embodiment of a system 2300 for tree encoding and decoding. The system 2300 includes at least one processor (not shown) and a memory (not shown) with computer code instructions (not shown) stored thereon. The at least one processor and the memory, with the computer code instructions, may be configured to cause the system 2300 to execute an encoder 2310. The encoder 2310 may be configured to transform a first incomplete binary ordered tree data structure 2302a into a first tree encoding 2304a based on an encoding scheme 2312. The first tree encoding 2304a may include a first Dyck word 2306a and a first leaf vector 2308a. The encoding scheme 2312 may be capable of representing an arbitrary potentially incomplete binary ordered tree data structure (not shown) in terms of a Dyck word (not shown) and a leaf vector (not shown). The at least one processor and the memory, with the computer code instructions, may be further configured to cause the system 2300 to execute a decoder 2320. The decoder 2320 may be configured to transform a second tree encoding 2304b into a second incomplete binary ordered tree data structure 2302b, where the second tree encoding 2304b includes a second Dyck word 2306b and a second leaf vector 2308b, by traversing the second tree encoding 2304b and incrementally parsing the second leaf vector 2308b.

Aspects of the system 2300 of FIG. 23 may be as described in Allen et al., “EDEN—a practical, SNARK-friendly combinator VM and ISA,” Cryptology ePrintArchive, 2023, pp. 1-34 and Allen et al., “Airwalk: Accessible Decentralized Ledgers with State-Minimization and Unlinkable Smart Transactions,” pp. 1-41, both of which are herein incorporated by reference in their entirety and further attached hereto as Appendices A and B, respectively.

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein. It should be understood that elements of the block and flow diagrams may be implemented in software or hardware, such as via one or more arrangements of circuitry of FIG. 19, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as RAM, ROM, compact disk read-only memory (CD-ROM), and so forth. In operation, a general-purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

It should be understood that the term “blockchain” as used herein includes all forms of electronic, computer-based distributed ledgers. These include consensus-based blockchain and transaction-chain technologies, permissioned and un-permissioned ledgers, shared ledgers and variations thereof. While Bitcoin and Ethereum may be referred to herein for the purpose of convenience and illustration, it should be noted that the disclosure is not limited to use with the Bitcoin or Ethereum blockchains and alternative blockchain implementations and protocols fall within the scope of the present disclosure.

It should also be noted that not all currently known distributed ledger systems utilize linear blockchains as such. Some known blockchain implementations utilize lattice or mesh data structure(s), and some utilize directed acyclic graphs (DAGs).

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system for state minimization and unlinkable transactions, the computer-based system comprising:
a zero-knowledge virtual machine (VM);
a state-minimized decentralized ledger including multiple blocks,
the state-minimized decentralized ledger configured as a dynamic cryptographic accumulator implementing a decentralized ledger protocol; and
a blockchain computer network including multiple nodes,
at least one of the multiple nodes configured to execute a zero-knowledge verifier system,
the zero-knowledge verifier system configured to:
via the zero-knowledge virtual machine (VM):
verify a block of the multiple blocks based on (i) a block header of the block and (ii) at least one zero-knowledge proof (ZKP) of the multiple blocks, the block associated with an electronic transaction; and
recursively verify a corresponding zero-knowledge proof (ZKP) of at least one predecessor block of the block;
generate an unlinkable transaction by obfuscating a correlation between a source node of the multiple nodes and a destination node of the multiple nodes, the source node and the destination node associated with the electronic transaction; and
validate the electronic transaction by verifying a zero-knowledge proof (ZKP) corresponding to the generated unlinkable transaction, the zero-knowledge proof (ZKP) configured to attest to (i) correctness of the generated unlinkable transaction and (ii) satisfaction of smart contract logic associated with a digital wallet.

2. The computer-based system of claim 1, wherein the dynamic cryptographic accumulator includes a sparse Merkle tree.

3. The computer-based system of claim 2, wherein the state-minimized decentralized ledger is configured to computationally index at least one leaf of the sparse Merkle tree based on at least one content predicate.

4. The computer-based system of claim 1, wherein the dynamic cryptographic accumulator is configured to perform a non-inclusion proof.

5. The computer-based system of claim 1, wherein the digital wallet is a first digital wallet, and wherein the zero-knowledge verifier system is further configured to:
implement a binding between a second digital wallet and a smart contract, the smart contract including at least one covenant module configured to apply a conditional constraint to at least one future transaction associated with the second digital wallet.

6. The computer-based system of claim 1, wherein the digital wallet is a first digital wallet, and wherein the zero-knowledge verifier system is further configured to:
determine a state penalty value for a second digital wallet corresponding to the destination node, the state penalty value associated with a state entry for the second digital wallet in the state-minimized decentralized ledger; and
responsive to receiving a state trim request from the destination node, computationally purge the state entry in the state-minimized decentralized ledger.

7. The computer-based system of claim 1, wherein:
the at least one of the multiple nodes includes a secure cryptoprocessor implemented as a dedicated microprocessor configured to execute the zero-knowledge verifier system; and
the zero-knowledge verifier system is embedded on the secure cryptoprocessor.

8. A computer-implemented method for state minimization and unlinkable transactions, the computer-implemented method comprising:
via a zero-knowledge virtual machine (VM):
verifying a block of multiple blocks of a state-minimized decentralized ledger based on (i) a block header of the block and (ii) at least one zero-knowledge proof (ZKP) of the multiple blocks, the block associated with an electronic transaction, the state-minimized decentralized ledger configured as a dynamic cryptographic accumulator implementing a decentralized ledger protocol; and
recursively verifying a corresponding zero-knowledge proof (ZKP) of at least one predecessor block of the block;
generating an unlinkable transaction by obfuscating a correlation between a source node of multiple nodes of a blockchain computer network and a destination node of the multiple nodes, the source node and the destination node associated with the electronic transaction; and
validating the electronic transaction by verifying a zero-knowledge proof (ZKP) corresponding to the generated unlinkable transaction, the zero-knowledge proof (ZKP) configured to attest to (i) correctness of the generated unlinkable transaction and (ii) satisfaction of smart contract logic associated with a digital wallet.

9. The computer-implemented method of claim 8, further comprising:
configuring the dynamic cryptographic accumulator with a sparse Merkle tree.

10. The computer-implemented method of claim 9, further comprising:
computationally indexing at least one leaf of the sparse Merkle tree based on at least one content predicate.

11. The computer-implemented method of claim 8, further comprising:
configuring the dynamic cryptographic accumulator to perform a non-inclusion proof.

12. The computer-implemented method of claim 8, wherein the digital wallet is a first digital wallet, and further comprising:
implementing a binding between a second digital wallet and a smart contract, the smart contract including at least one covenant module configured to apply a conditional constraint to at least one future transaction associated with the second digital wallet.

13. The computer-implemented method of claim 8, wherein the digital wallet is a first digital wallet, and further comprising:
determining a state penalty value for a second digital wallet corresponding to the destination node, the state penalty value associated with a state entry for the second digital wallet in the state-minimized decentralized ledger; and
responsive to receiving a state trim request from the destination node, computationally purging the state entry in the state-minimized decentralized ledger.

14. A computer-based system for tree encoding and decoding, the computer-based system comprising:
at least one processor; and
a memory with computer code instructions stored thereon, the at least one processor and the memory, with the computer code instructions, configured to cause the computer-based system to:
execute an encoder, the encoder configured to transform a first incomplete binary ordered tree data structure into a first tree encoding based on an encoding scheme, the first tree encoding including a first Dyck word and a first leaf vector, the encoding scheme capable of representing an arbitrary potentially incomplete binary ordered tree data structure in terms of a Dyck word and a leaf vector; and
execute a decoder, the decoder configured to transform a second tree encoding into a second incomplete binary ordered tree data structure, the second tree encoding including a second Dyck word and a second leaf vector, by:
traversing the second tree encoding; and
incrementally parsing the second leaf vector.

15. The computer-based system of claim 14, wherein:
the decoder is further configured to generate a subtree data structure based on a subtree index variable.

16. The computer-based system of claim 14, further comprising:
a virtual machine (VM) configured with a potentially incomplete ordered tree based memory model;
wherein:
the virtual machine (VM) is further configured with the encoding scheme; and
the virtual machine (VM) is further configured with at least one of the encoder and the decoder.

17. The computer-based system of claim 14, further comprising:
a cryptographic proof system configured to, based on the encoding scheme, represent a first statement of computational integrity in terms of polynomials defined over finite fields, the first statement of computational integrity relating to at least one of traversal and modification of at least one potentially incomplete binary ordered tree data structure.

18. The computer-based system of claim 17, wherein:
the cryptographic proof system is further configured to, based on the encoding scheme, verify a second statement of computational integrity, the second statement of computational integrity (i) being in terms of polynomials defined over finite fields and (ii) relating to at least one of traversal and modification of at least one potentially incomplete binary ordered tree data structure.

19. The computer-based system of claim 14, wherein:
the encoder is further configured to process a polynomial-based representation of a computational integrity statement, the polynomial-based representation being associated with a zero-knowledge proof (ZKP) system.

20. The computer-based system of claim 19, wherein:
the zero-knowledge proof (ZKP) system is at least one of a STARK (Scalable Transparent Arguments of Knowledge) based system and a SNARK (Succinct Non-Interactive Arguments of Knowledge) based system.
